(19) United States
(12) Patent Application Publication
(10) Pub. No.: US 2011/0047007 A1
(43) Pub. Date: Feb. 24, 2011

(54) SYSTEM AND METHOD FOR COMMUNITY-BASED DISPUTE RESOLUTION

(76) Inventor: Colin Rule, San Jose, CA (US)

Correspondence Address: SCHWEGMAN, LUNDBERG & WOESSNER/EBAY, P.O. BOX 2938, MINNEAPOLIS, MN, 55402, US

(21) Appl. No.: 12/544,927

(22) Filed: Aug. 20, 2009

(51) Int. Cl. G06Q 30/00; G06Q 10/00

(52) U.S. Cl. 705/11; 705/309

(57) ABSTRACT

There is provided a method and system to enable resolving a dispute using a networked dispute resolution environment. Jurors may be selected from members of a network-based community. A panel of jurors including one or more members is formed and provided evidence associated with the dispute for review. The evidence may include a description of the dispute and comments from at least one party to the dispute. A decision on the dispute based on input received from the panel is then determined. The input may comprise one or more votes received from the panel.

### RELATED APPLICATIONS

This application is related to U.S. patent application Ser. No. 11/195,578, filed Aug. 2, 2005, and entitled METHOD AND SYSTEM TO DESIGN A DISPUTE RESOLUTION PROCESS. This application is also related to U.S. patent application Ser. No. 11/643,578, filed Dec. 21, 2006, and entitled SYSTEM AND METHOD FOR UNIFIED DISPUTE RESOLUTION. The content of the aforementioned applications are incorporated herein by reference.

### TECHNICAL FIELD

The present application relates generally to the technical field of dispute resolution and, in one example, to a system and method to resolve disputes electronically based on input provided by some members of an online community.

### BACKGROUND

Buyers and sellers that transact goods and services in electronic marketplaces sometimes disagree. To resolve their dispute the buyer or seller may request the services of an online dispute resolution provider. Indeed, the party that requests the services, the complainant, may be unaware of the variety of providers and services that may be used to optimally settle the dispute.

### BRIEF DESCRIPTION OF THE DRAWINGS

The present invention is illustrated by way of example and not limitation in the figures of the accompanying drawings, in which like references indicate similar elements and in which:

FIG. 1 is a network diagram depicting a system, according to an example embodiment of the present invention;

FIG. 2 is a block diagram illustrating multiple marketplace and payment applications, according to an example embodiment of the present invention;

FIG. 3 is a block diagram illustrating database tables, according to an example embodiment;

FIG. 4 is a block diagram illustrating a dispute resolution table, according to an example embodiment;

FIG. 5 is a block diagram illustrating a transaction table, according to an example embodiment;

FIG. 6 is a block diagram illustrating a user table, according to an example embodiment;

FIG. 7 is a block diagram illustrating an item table, according to an example embodiment;

FIG. 8 is a block diagram illustrating dispute resolution applications, according to an example embodiment;

FIG. 9 is a block diagram illustrating component processes, according to an example embodiment;

FIG. 10 is a flowchart illustrating a method to enable a complainant to automatically design a dispute resolution process from a plurality of component processes, according to an example embodiment;

FIG. 11 is a flowchart illustrating a method to receive characterization information, according to an example embodiment, that is used to characterize a dispute;

FIG. 12 is a block diagram illustrating a dispute resolution wizard, according to an example embodiment;

FIG. 13 is a block diagram illustrating a dispute resolution table, according to an example embodiment;

FIG. 14 is a flowchart illustrating a method to enable access to deliberation information associated with a second dispute to facilitate resolution of a first dispute, according to an example embodiment;

FIG. 15 is a block diagram illustrating a dispute resolution wizard, according to an example embodiment;

FIG. 16 is a block diagram illustrating a dispute resolution table, according to an example embodiment;

FIG. 17 is a flowchart illustrating a method, according to an example embodiment, to assist a review of a plurality of component processes that respectively utilized to facilitate the resolution of a dispute;

FIG. 18 is a flowchart illustrating a method, according to an example embodiment, to independently review feedback;

FIGS. 19-25 are representations of user interfaces, according to an example embodiment;

FIG. 26 is an example of a disputant interface;

FIG. 27 is an example of a juror interface;

FIG. 28A is an example of a juror application interface;

FIG. 28B is an example of a juror voting interface;

FIG. 28C is an example of a juror performance statistic interface;

FIG. 29 is an example of a dispute result interface;

FIG. 30 is an example of a dispute summary interface;

FIG. 31 is a flowchart illustrating a method, according to an example embodiment, to resolve a dispute; and

FIG. 32 a block diagram of a machine, according to an example embodiment, including instructions to perform any one or more of the methodologies described herein.

### DETAILED DESCRIPTION

A method and system for community-based dispute resolution are described. In the following description, for purposes of explanation, numerous specific details are set forth in order to provide a thorough understanding of example embodiments. It will be evident, however, to one skilled in the art that the example embodiments may be practiced without these specific details. Further, well-known instruction instances, protocols, structures, and techniques have not been shown in detail.

As used herein, the term “or” may be construed in either an inclusive or exclusive sense. Additionally, although various example embodiments discussed below focus on a network-based marketplace environment, the embodiments are given merely for clarity in disclosure. Thus, any type of electronic commerce or electronic business system and method, including various system architectures, may employ various embodiments of the system and method described herein and is considered as being within a scope of exemplary embodiments. Each of a variety of exemplary embodiments is discussed in detail, below.

According to an example embodiment, there is provided a method and a system for community-based dispute resolution. In an example embodiment, the system may include a dispute resolution wizard that receives characterization information from a complainant that characterizes a dispute between the complainant and a respondent. The characterization information may include a transaction number and descriptive information that articulates the facts and circumstances of the dispute. The dispute resolution wizard uses the characterization information to identify online dispute resolution processes (e.g., component processes) that may be utilized to settle the dispute. The system generates a user interface that includes the component processes and communicates the user interface to the complainant who may select a set of component processes and a desired order of execution of the component processes to design a dispute resolution process. The dispute resolution wizard may subsequently facilitate an exchange of communications between the complainant and respondent who may agree on a final version of the dispute resolution process. Finally, the dispute resolution wizard may use the final version of the dispute resolution process to automatically and sequentially initiate execution of the component processes until the component processes are exhausted or the dispute is settled.

In a further example embodiment, there is provided a method and a system to enable a user to access to deliberation information associated with one or more disputes that are factually similar to the user's dispute. In an example embodiment, the system may include a dispute resolution wizard that receives characterization information from the user that may characterize a dispute that is of interest to the user. The dispute resolution wizard may use the characterization information to search a database to identify disputes that match or correspond (e.g., correspond to the characterization information) and retrieve deliberation information associated with each of the matching disputes. Deliberation information may include information that may document efforts (e.g., undertaken by parties, neutrals, mediators, arbitrators, experts, witnesses, manual processes, electronic processes, etc.) towards the settlement of a dispute. For example, deliberation information may include the identity of a component processes that may be used towards settlement of a dispute (e.g., mediation, arbitration, etc.) and information associated with the component process (e.g., name of provider, elapsed time, result of execution of component process, email, documents, listing, opinions, etc.). The dispute resolution wizard may generate user interfaces that include the deliberation information and communicate the user interfaces to the user to facilitate resolution of the dispute that is of interest to the user.

According to further embodiments, there is provided a method and a system to assist a review of multiple component processes (e.g., mediation, arbitration, etc.) that may be used to facilitate the resolution of a dispute. In an example embodiment, the system may include a dispute resolution wizard that receives characterization information from a user that may be used to characterize a dispute that is of interest to the user. The dispute resolution wizard may use the characterization information to search a database to identify matching or corresponding disputes. The dispute resolution wizard may then retrieve component processes that were used towards resolving each of the corresponding disputes and associated outcome information. For example, outcome information may include whether execution of a particular component process resulted in settlement for the buyer, settlement for the seller, or a compromise. The dispute resolution wizard may use the outcome information from multiple matching disputes to compute aggregate outcome information (e.g., settlement rates) that are included in user interfaces and communicated to the user. The aggregate outcome information may assist the user in reviewing component processes that may be used to settle the dispute that is of interest to the user.

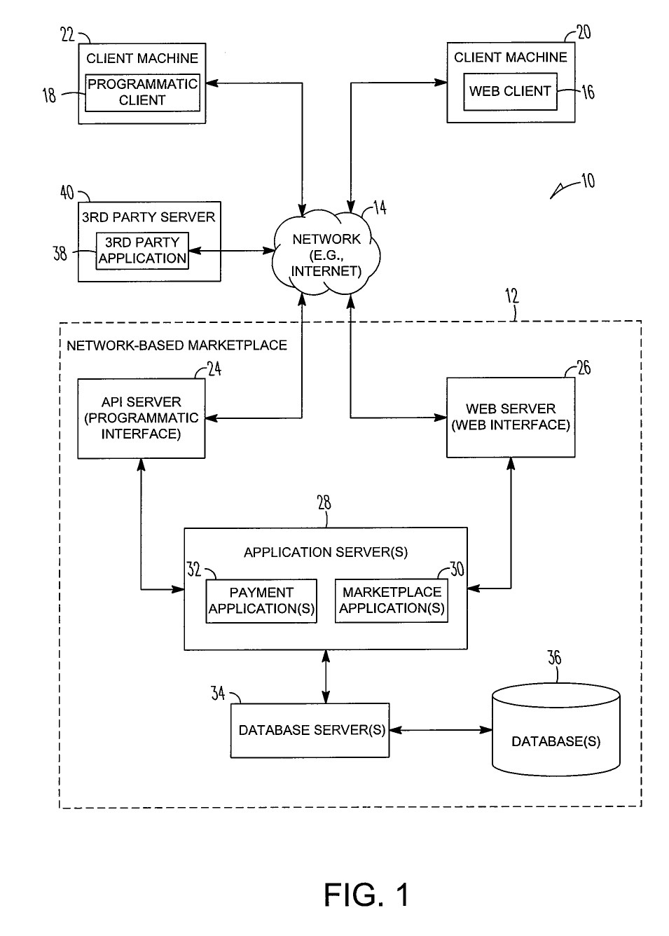

FIG. 1 is a network diagram depicting a system 10, according to an example embodiment of the present invention, having a client-server architecture. A commerce platform, in the example form of a network-based marketplace 12, provides server-side functionality, via a network 14 (e.g., the Internet) to one or more clients. FIG. 1 illustrates, for example, a web client 16 (e.g., a browser, such as the Internet Explorer browser developed by Microsoft Corporation of Redmond, Wash. State), and a programmatic client 18 executing on respective client machines 20 and 22.

Turning specifically to the network-based marketplace 12, an Application Program Interface (API) server 24 and a web server 26 are coupled to, and provide programmatic and web interfaces respectively to, one or more application servers 28. The application servers 28 host one or more marketplace applications 30 and payment applications 32. The application servers 28 are, in turn, shown to be coupled to one or more databases servers 34 that facilitate access to one or more databases 36.

The marketplace applications 30 provide a number of marketplace functions and services to users that access the marketplace 12. The payment applications 32 likewise provide a number of payment services and functions to users. The payment applications 32 may allow users to quantify for and accumulate value (e.g., in a commercial currency, such as the U.S. dollar, or a proprietary currency, such as “points”) in accounts, and then later to redeem the accumulated value for products (e.g., goods or services) that are made available via the marketplace applications 30. In addition, the payment applications may include component processes that may be utilized to settle disputes between users (e.g., auction winners/buyers and sellers) that have transacted items (e.g., goods and services). While the marketplace and payment applications 30 and 32 are shown in FIG. 1 to both form part of the network-based marketplace 12, it will be appreciated that, in alternative embodiments of the present invention, the payment applications 32 may form part of a payment service that is separate and distinct from the marketplace 12.

Further, while the system 10 shown in FIG. 1 employs a client-server architecture, the present invention is not limited to such an architecture, and can equally well find application in a distributed or peer-to-peer architecture system. The various marketplace and payment applications 30 and 32 can also be implemented as standalone software programs, which do not necessarily have networking capabilities.

The web client 16, it will be appreciated, accesses the various marketplace and payment applications 30 and 32 via the web interface supported by the web server 26. Similarly, the programmatic client 18 accesses the various services and functions provided by the marketplace and payment applications 30 and 32 via the programmatic interface provided by the API server 24. The programmatic client 18 may, for example, be a seller application (e.g., the TurboLister application developed by eBay Inc., of San Jose, Calif.) to enable sellers to author and manage listings on the marketplace 12 in an off-line manner, and to perform batch-mode communications between the programmatic client 18 and the network-based marketplace 12.

FIG. 1 also illustrates a third party application 38, executing on a third party server machine 40, as having programmatic access to the network-based marketplace 12 via the programmatic interface provided by the API server 24. For example, the third party application 38 may, utilizing information retrieved from the network-based marketplace 12, support one or more features or functions on a website hosted by the third party. The third party website may, for example, provide one or more promotional, marketplace, or payment functions that are supported by the relevant applications of the network-based marketplace 12 or component processes that may be utilized to settle disputes between users (e.g., auction winners/buyers and sellers) that have transacted items on the network based marketplace 12.

### Marketplace Applications

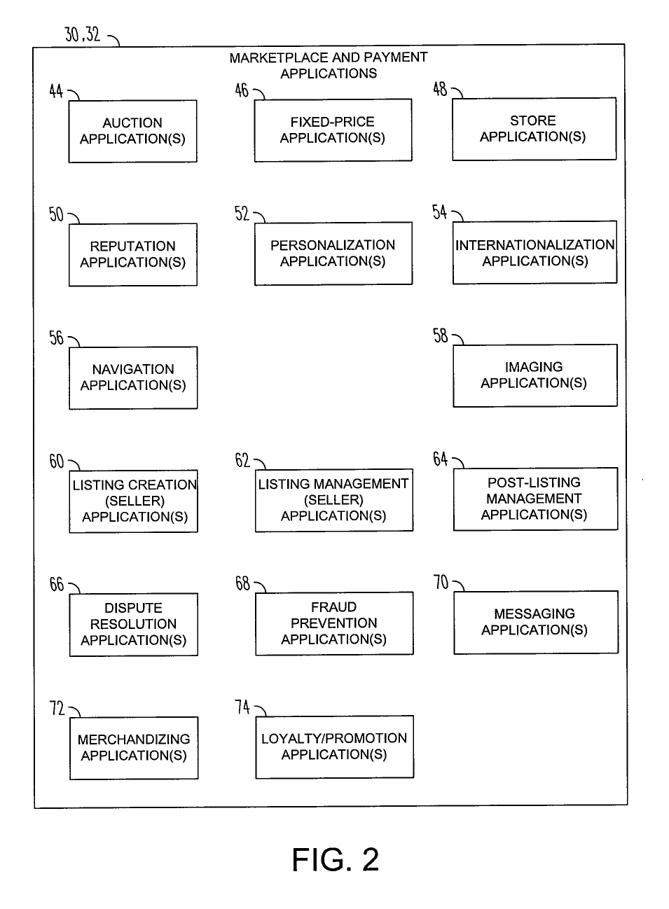

FIG. 2 is a block diagram illustrating multiple marketplace and payment applications 30 and 32 that, in an example embodiment of the present invention, are provided as part of the network-based marketplace 12. The marketplace 12 may provide a number of listing and price-setting mechanisms whereby a seller may list goods or services for sale, a buyer can express interest in or indicate a desire to purchase such goods or services, and a price can be set for a transaction pertaining to the goods or services. To this end, the marketplace and payment applications 30 and 32 are shown to include one or more auction applications 44 which support auction-format listing and price setting mechanisms (e.g., English, Dutch, Vickrey, Chinese, Double, or Reverse auctions). The various auction applications 44 may also provide a number of features in support of such auction-format listings, such as a reserve price feature whereby a seller may specify a reserve price in connection with a listing, and a proxy-bidding feature whereby a bidder may invoke automated proxy bidding.

A number of fixed-price applications 46 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with an auction-format listing, and allow a buyer to purchase goods or services, which are also being offered for sale via an auction, for a fixed-price that is typically higher than the starting price of the auction.

Store applications 48 allow sellers to group their listings within a “virtual” store, which may be branded and otherwise personalized by and for the sellers. Such a virtual store may also offer promotions, incentives, and features that are specific and personalized to a relevant seller.

Reputation applications 50 allow parties that transact utilizing the network-based marketplace 12 to establish, build, and maintain reputations, which may be made available and published to potential trading partners. Consider that where, for example, the network-based marketplace 12 supports person-to-person trading, users may have no history or other reference information whereby the trustworthiness and credibility of potential trading partners may be assessed. The reputation applications 50 allow a user, for example, through feedback provided by other transaction partners, to establish a reputation within the network-based marketplace 12 over time. Other potential trading partners may then reference such a reputation for the purposes of assessing credibility and trustworthiness. In an example embodiment, a single feedback may include comment and a score (e.g., −1 to register negative feedback, 0 to register neutral feedback, and +1 to register positive feedback). Further, scores may be analyzed to generate a feedback rating that is associated with a user. Other users in the network-based marketplace 12 may access the feedback rating to assess the reputation of the user.

Personalization applications 52 allow users of the marketplace 12 to personalize various aspects of their interactions with the marketplace 12. For example a user may, utilizing an appropriate personalization application 52, create a personalized reference page at which information regarding transactions to which the user is (or has been) a party may be viewed. Further, a personalization application 52 may enable a user to personalize listings and other aspects of their interactions with the marketplace 12 and other parties.

In an example embodiment, internationalization applications 54 may support a number of marketplaces that are customized, for example, for specific geographic regions. A version of the marketplace 12 may be customized for the United Kingdom, whereas another version of the marketplace 12 may be customized for the United States. Each of these versions may operate as an independent marketplace, or may be customized (or internationalized) presentations of a common underlying marketplace.

Navigation of the network-based marketplace 12 may be facilitated by one or more navigation applications 56. For example, a search application enables key word searches of listings published via the marketplace 12. A browse application allows users to browse various category, catalogue, or inventory data structures according to which listings may be classified within the marketplace 12. Various other navigation applications 56 may be provided to supplement the search and browsing applications.

In order to make listings, available via the network-based marketplace 12, as visually informing and attractive as possible, the marketplace applications 30 may include one or more imaging applications 58 utilizing which users may upload images for inclusion within listings. An imaging application 58 also operates to incorporate images within viewed listings. The imaging applications 58 may also support one or more promotional features, such as image galleries that are presented to potential buyers. For example, sellers may pay an additional fee to have an image included within a gallery of images for promoted items.

Listing creation applications 60 allow sellers conveniently to author listings pertaining to goods or services that they wish to transact via the marketplace 12, while listing management applications 62 allow sellers to manage such listings. Specifically, where a particular seller has authored and/or published a large number of listings, the management of such listings may present a challenge. The listing management applications 62 provide a number of features (e.g., auto-relisting, inventory level monitors, etc.) to assist the seller in managing such listings. One or more post-listing management applications 64 also assist sellers with a number of activities that typically occur post-listing. For example, upon completion of an auction facilitated by one or more auction applications 44, a seller may wish to leave feedback regarding a particular buyer. To this end, a post-listing management application 64 may provide an interface to one or more reputation applications 50, so as to allow the seller conveniently to provide feedback regarding multiple buyers to the reputation applications 50.

Dispute resolution applications 66 provide mechanisms whereby disputes arising between transacting parties may be resolved. For example, the dispute resolution applications 66 may provide processes (e.g., dispute resolution wizard, component processes, a document management application, etc.) whereby the parties are automatically guided through a number of steps in an attempt to settle a dispute. The dispute may be settled by a third party provider.

A number of fraud prevention applications 68 implement various fraud detection and prevention mechanisms to reduce the occurrence of fraud within the marketplace 12.

Messaging applications 70 are responsible for the generation and delivery of messages to users of the network-based marketplace 12, such messages for example advising users regarding the status of listings at the marketplace 12 (e.g., providing “outbid” notices to bidders during an auction process or to provide promotional and merchandising information to users).

Merchandising applications 72 support various merchandising functions that are made available to sellers to enable sellers to increase sales via the marketplace 12. The merchandising applications 72 also operate the various merchandising features that may be invoked by sellers, and may monitor and track the success of merchandising strategies employed by sellers.

The network-based marketplace 12 itself, or one or more parties that transact via the marketplace 12, may operate loyalty programs that are supported by one or more loyalty/promotions applications 74. For example, a buyer may earn loyalty or promotions points for each transaction established and/or concluded with a particular seller, and be offered a reward for which accumulated loyalty points can be redeemed.

### Data Structures

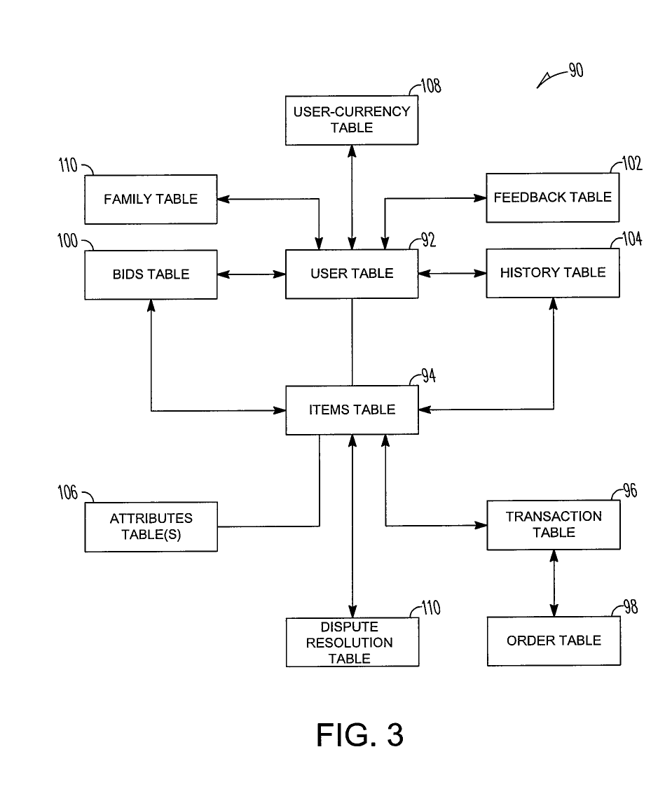

FIG. 3 is a high-level entity-relationship diagram, illustrating various tables 90 that may be maintained within the databases 36, and that are utilized by and support the marketplace and payment applications 30 and 32. A user table 92 contains a record for each registered user of the network-based marketplace 12, and may include identifier, address, and financial instrument information pertaining to each such registered user. A user may, it will be appreciated, operate as a seller, a buyer, or both, within the network-based marketplace 12. In an example embodiment of the present invention, a buyer may be a user that has accumulated value (e.g., commercial or proprietary currency), and is able to exchange the accumulated value for items that are offered for sale by the network-based marketplace 12.

The tables 90 also include an items table 94 in which are maintained item records for goods and services that are available to be, or have been, transacted via the marketplace 12. Each item record within the items table 94 may furthermore be linked to one or more user records within the user table 92, so as to associate a seller and one or more actual or potential buyers with each item record.

A transaction table 96 contains a record for each transaction (e.g., a purchase transaction) pertaining to items for which records exist within the items table 94.

An order table 98 is populated with order records, each order record being associated with an order. Each order, in turn, may be with respect to one or more transactions for which records exist within the transactions table 96.

Bid records within a bids table 100 each relate to a bid received at the network-based marketplace 12 in connection with an auction-format listing supported by an auction application 44. A feedback table 102 is utilized by one or more reputation applications 50, in an example embodiment, to construct and maintain reputation information concerning users. A history table 104 maintains a history of transactions to which a user has been a party. One or more attributes tables 106 record attribute information pertaining to items for which records exist within the items table 94. Considering only a single example of such an attribute, the attributes tables 106 may indicate a currency attribute associated with a particular item, a user currency table 108 identifying the currency of a price for the relevant item as specified in by a seller. A dispute resolution table 110 may store dispute information that may be utilized to characterize disputes along with various other information regarding disputes.

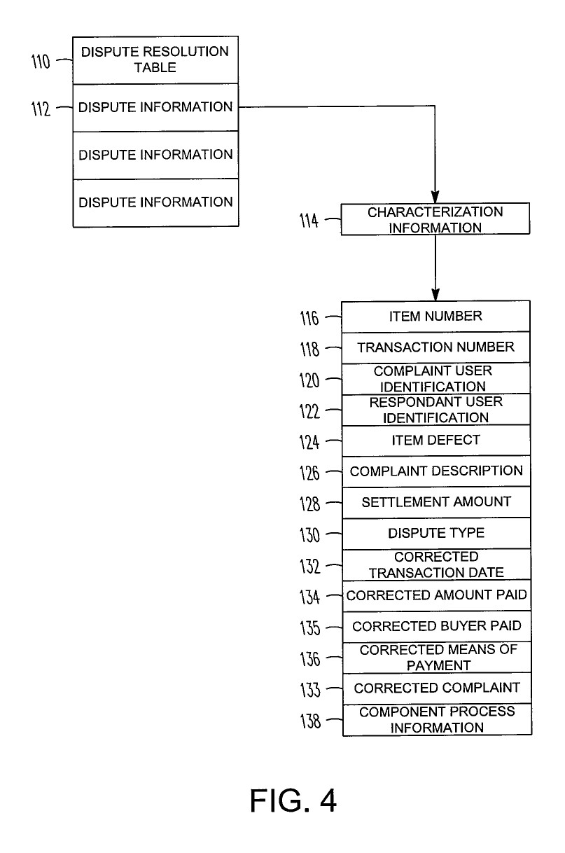

FIG. 4 is a block diagram illustrating the dispute resolution table 110, according to an example embodiment. The dispute resolution table 110 is shown to include multiple entries identified as dispute information 112. Each dispute information 112 may be associated to a dispute that is tracked by the network based marketplace 12. The dispute information 112 includes characterization information 114 that is utilized to characterize the dispute. The characterization information 114 includes an item number 116, a transaction number 118, a complainant user identification 120, a respondent user identification 122, an item defect (e.g., description of defected item) 124, a complaint description 126, a settlement amount 128, and a dispute type 130. In addition, the characterization information 114 is shown to include information that the user may have corrected including a corrected transaction date 132, a corrected amount paid 134, a corrected buyer paid 135, a corrected means of payment 136, and a corrected complainant 133. Finally, the characterization information 114 includes component process information 138. The item number 116 identifies an item that is associated with the dispute. The item number 116 may be utilized to access additional item information in the items table 94. The transaction number 118 identifies a transaction that is associated with the dispute. The transaction number 118 may be utilized to access additional transaction information in the transaction table 96. The complainant user identification 120 may be utilized to identify the complainant (e.g., that party that initially submits a complaint or dispute) which may be a user (e.g., buyer, seller, etc.) in the network-based marketplace 12. The complainant user identification 120 may be utilized to access additional user information in the user table 92. The respondent user identification 122 may be utilized to uniquely identify the respondent (e.g., responds to complaint) and to access additional user information in the user table 92. The item defect 124 may be a description of a defect of an item (e.g., text, slides, graph, photo, etc.). The complaint description 126 may be a description of the complaint entered by the complainant. The settlement amount 128 may be an amount of currency for which the complainant is willing to settle the dispute. The corrected transaction date 132 may be entered by the user to correct a transaction date retrieved by the network-based marketplace 12. The corrected amount paid 134 may be entered by the user to correct an amount paid retrieved by the network-based marketplace 12. The corrected buyer paid 135 may be entered by the buyer to correct a buyer paid flag (e.g., asserted if buyer has already paid) retrieved by the network-based marketplace 12. The corrected means of payment 136 may be entered by the buyer to correct a means of payment indication (e.g., visa credit card, check, etc.) retrieved by the network-based marketplace 12. The component process information 138 is discussed later in this document.

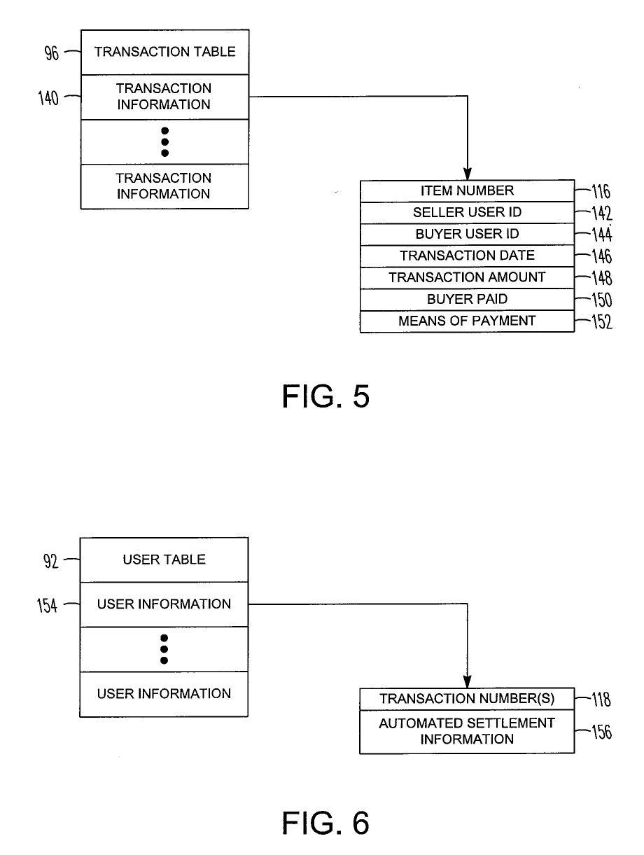

FIG. 5 is a block diagram illustrating a transaction table 96, according to an example embodiment. The transaction table 96 includes multiple entries of transaction information 140. Each transaction information 140 entry is associated with a transaction in the network-based marketplace 12 and may include an item number 116, as previously described, seller user identification 142, buyer user identification 144, a transaction date 146, a transaction amount 148, buyer paid 150, and a means of payment 152. The seller user identification 142 may be utilized to identify the seller associated with the transaction. The seller user identification 142 may be utilized to access additional user information in the user table 92. The buyer user identification 144 may be utilized to identify the buyer associated with the transaction which may be a user in the network-based marketplace 12. The buyer user identification 144 may be utilized to access additional user information in the user table 92. The transaction date 146 may be the date the transaction was completed (e.g., date buyer agrees to pay or date an auction closes or date the buyer or bidder has placed the winning bid, etc.). The transaction amount 148 may be the amount of currency (e.g., US Dollars, English pounds, proprietary currency, etc.) agreed to be exchanged for the associated item (e.g., good or service) identified by the item number 116. The buyer paid 150 may be a buyer provided indication of whether the buyer has paid. The means of payment 152 may indicate the means of payment by the buyer (e.g., cash, check, visa credit card, payment service, etc.).

FIG. 6 is a block diagram illustrating a user table 92, according to an example embodiment. The user table 92 is shown to include multiple user information 154 entries. Each user information 154 entry is associated with a user (e.g., buyer/bidder, seller) that utilizes the network-based marketplace 12. The user information 154 entry is shown to include one or more transaction numbers 118, previously described, and automated settlement information 156. The automated settlement information 156 may be seller provided settlement information (e.g., monetary amounts) that may be automatically utilized by a monetary settlement component process to settle disputes. For example, a seller that transacts high volumes of a particular item may not be interested in becoming personally involved with a dispute that may be settled below a certain monetary value. In such instances, the seller may automatically provide offers in the form of monetary amounts that may be utilized by a monetary component process that compares demands (e.g. from the seller) with offers (e.g., from the buyer), typically in three rounds, to arrive at a settlement. The monetary component process is described more fully below.

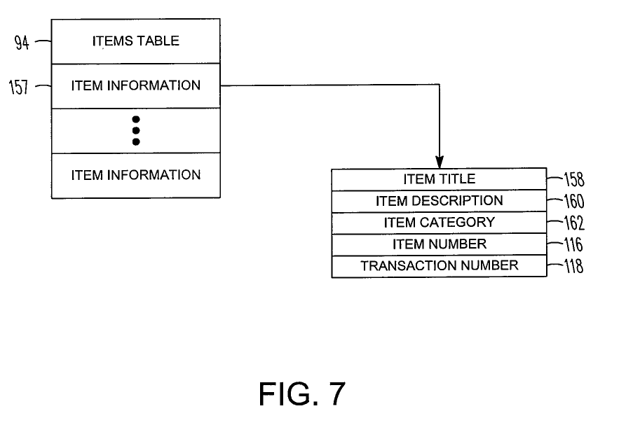

FIG. 7 is a block diagram illustrating an items table 94, according to an example embodiment. The items table 94 is shown to include multiple item information 157 entries. Each item information 157 entry is associated with an item listing (e.g., describing goods or services) that is utilized to present the item on the network-based marketplace 12. The item information 157 entry is shown to include an item title 158, an item description 160, an item category 162, an item number 116, as previously described, and a transaction number 118, as previously described. The item title 158, item description 160, and item category 162 are entered by the seller. In some embodiments, more than a single item category 162 may be entered (e.g., snorkeling gear, swimming, recreation, sporting goods, etc.) for the same item. The item description may include text, graphics, and photographs.

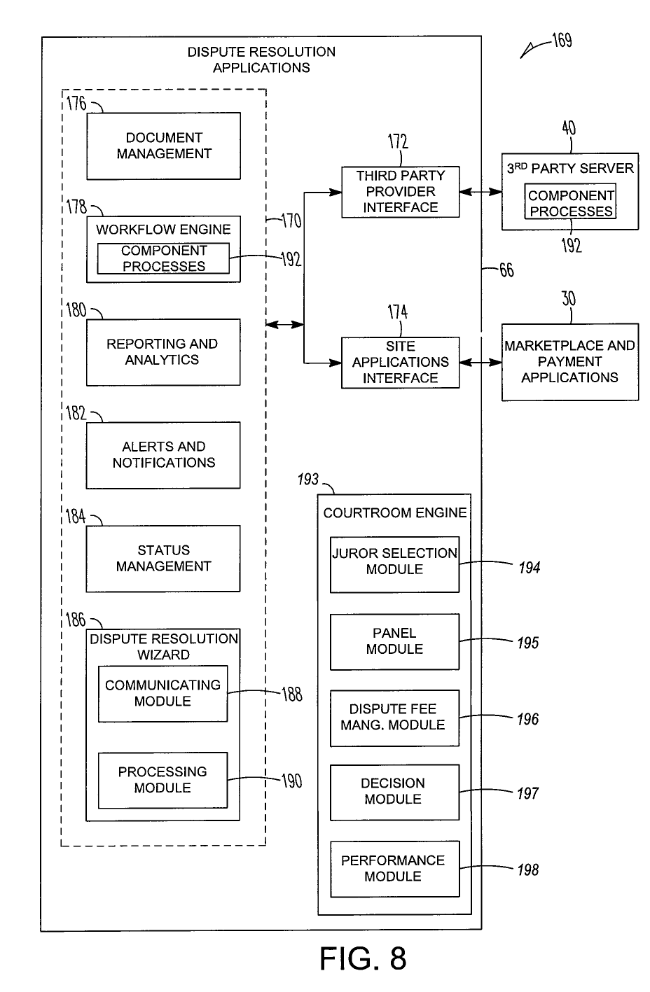

FIG. 8 is a block diagram illustrating a dispute resolution system 169, according to an example embodiment. The dispute resolution system 169 is shown to include the dispute resolution applications 66, a third party server 40, and marketplace and payment applications 30 and 32. The dispute resolution applications 66 include dispute resolution core applications 170, a third party provider interface 172, and a site application interface 174. The dispute resolution applications 66 are shown to communicate via the third party provider interface 172 with the 3^{rd} party server 40 that may execute component processes 192 and via the site applications interface 174 with marketplace and payment applications 30 and 32. The dispute resolution core applications 170 include a document management application 176, a workflow engine 178, a reporting and analytics application 180, an alerts and notifications application 182, a status management application 184, and a dispute resolution wizard 186. The document management application 176 may provide services to enable users and processes to upload or send in documents and other types of electronic assets (e.g., any type of digital media that is stored electronically) to support resolution processes.

The workflow engine 178 represents disputes and executes component processes 192 in response to events (e.g., system timeouts, user actions including filing a complaint and other actions, etc.). The component process 192 may be discrete mechanisms to settle a dispute and may be completely or partially automated. Multiple component processes 192 may be selected by a complainant to settle a single dispute, and a single component process 192 is usually associated with published procedures and time tables for completing tasks that contribute towards the resolution of a dispute. A completed component process 192 may or may not result in the settlement of a dispute. The component processes 192 may be provided by an internal provider (e.g., executing on the network-based marketplace 12, payment service, etc.) or an external provider (e.g., executing on the third party server 40 including a dispute resolution provider, payment service, etc.).

The reporting and analytics application 180 provides users and administrators with reports including analysis pertaining to the processing of disputes, categories of disputes, status of disputes, and other dispute related processing. The reporting and analytics application 180 may also trigger alerts to external systems via the third party provider interface 172 and the site applications interface 174. The alerts and notifications application 182 communicate events and rules bases status notifications (e.g., emails, action alerts, pop ups, etc.) to the users (e.g., buyers/bidders, sellers). The status management application 184 may be used to provide users with a single area online for filing, checking on, and resolving all types of disputes and/or issues.

The dispute resolution wizard 186 enables a complainant to design a dispute resolution process from multiple component processes 192. The dispute resolution wizard 186 is shown to include a communicating module 188 and a processing module 190. The communicating module 188 receives information from a complainant that may be used to characterize the dispute and to access information in the database 36 that may be used to characterize the dispute. The processing module 190 may be used to determine if the characterized dispute is appropriate to settle with the component processes 192, identify one or more of the component processes 192 to settle the dispute, and communicate user interfaces to the complainant that enable the complainant to select the component processes 192 and their order of execution thereby designing a dispute resolution process.

FIG. 8 further comprises a courtroom engine 193 which enables an electronic court room for providing community-based dispute resolution. In example embodiments, the courtroom engine 193 includes a juror selection module 194, a panel module 195, a dispute fee management module 196, a decision module 197, and a performance module 197. It should be noted that the courtroom engine 193 may be located elsewhere within the dispute resolution applications 169. For example, the courtroom engine 193 may be a part of the component processes 192 or the dispute resolution wizard 186.

The juror selection module 194 manages and/or pre-qualifies jurors to serve on a panel. In some embodiments, potential jurors may apply or volunteer (via a volunteer request) to become a juror by responding to a set of questions provided by the juror selection module 194 pertaining to how they want to serve. In other embodiments, potential jurors may be invited by the juror selection module 194 to serve on one or more juries. The juror selection module 194 may further distinguish general jurors from specialist jurors. A specialist juror may be someone who has a certain level of expertise in a field more than a general juror. The juror selection process may occur prior to a dispute, resulting in creation of a pool of pre-qualified jurors ready to serve. Alternatively, the juror selection process may occur after a dispute is received. It is noted that the jurors are members of the network-based community in some embodiments.

The panel module 195 creates a panel of one or more jurors to adjudicate each dispute. In some embodiments, a single member may serve as a judge, and that member resolves the disputes based on information provided by the parties of the disputes. Alternatively, a jury or panel that includes multiple jurors with each juror being a member of the community may resolve the disputes. Selection of one or more jurors for the panel may be random, based on pre-set criteria, based on volunteering jurors, based on selection by one or both parties to the dispute, or any other criteria. It should be noted that the functions of the juror selection module 194 and the panel module 195 may be combined into a single module.

In some embodiments, the panel module 195 may further provide information to members of the panel. The information may be provided via a juror interface and include evidence associated with the dispute. The evidence may include a description of the dispute and comments from one or more parties (e.g., disputants) to the dispute. In alternative embodiments, the processing module 190 may provide the various interfaces to the disputants and panel.

The dispute fee management module 196 manages the collection of fees and payment of the jurors. In some embodiments, a fee may be charged to one of the disputants to have their disputes resolved by the jurors in one of the panels. The fee may be higher when the disputants agree to use the specialist jurors. The jurors may then be paid from the collected fees. Note that the reward to the juror may not be based purely on whether the juror votes for the first disputant or the second disputant. This prevents the jurors from favoring a certain voting trend that may enable them to control their rewards.

The decision module 197 determines a decision on a dispute based on input received from the panel. The input may comprise one or more votes from the jurors on the panel. In some embodiments, the decision module 197 determines a majority from the one or more votes in order to obtain the decision on the dispute.

The performance module 198 evaluates jurors. To enable fairness and to prevent abuse, a juror may be continuously monitored and evaluated to determine whether that juror continues to exhibit an ability to provide un-biased and fair judgment. A set of criteria may be used to monitor performance of the jurors to determine their qualification to remain as jurors. In example embodiments, the set of criteria may include one or more of a length of time that a juror takes to make a decision, whether the juror's decision is more often the decision of a majority of the jurors resolving the same dispute, how often the juror fails to provide a vote within the allotted time, and the number of disputes the juror voted on. Other criteria may also be used to determine the performance of the juror. Payment to each juror may be based, in part, on performance metrics determined by the performance module 198.

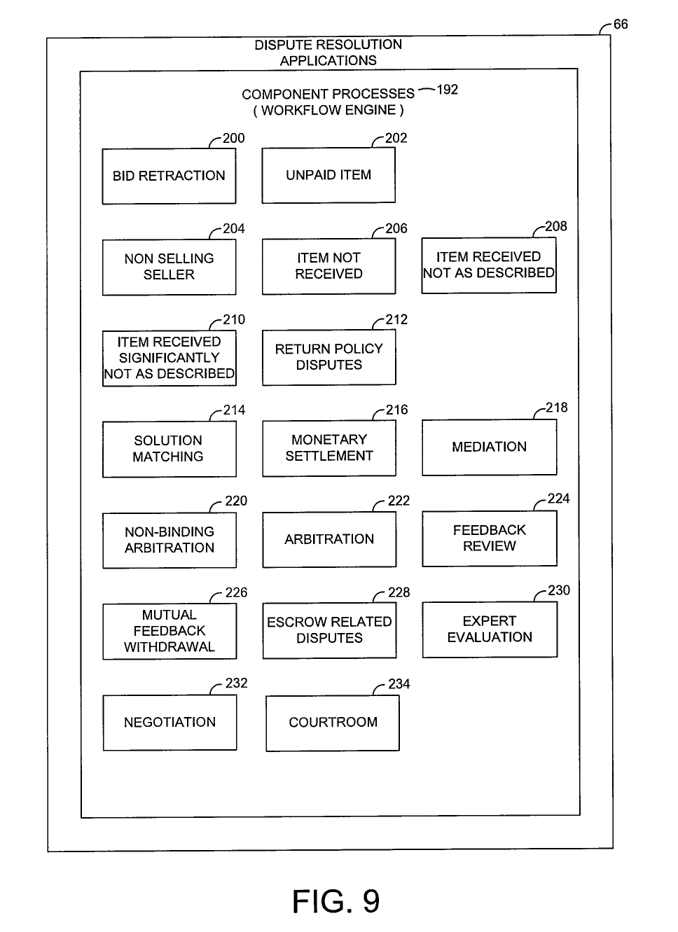

FIG. 9 is a block diagram illustrating the component processes 192, according to an example embodiment. The component processes 192 include a bid retraction component process 200, an unpaid item component process 202, a non-selling seller component process 204, an item not received component process 206, an item received not as described component process 208, an item received significantly not as described component process 210, a return policy disputes component process 212, a solution matching component process 214, a monetary settlement component process 216, a mediation component process 218, a non-binding arbitration component process 220, an arbitration component process 222, a feedback review component process 224, a mutual feedback withdrawal component process 226, an escrow related disputes component process 228, an expert evaluation component process 230, a negotiation component process 232, and a courtroom component process 234.

### Seller Initiated Complaints

The bid retraction component process 200 is an automated dispute resolution process that may be initiated by a seller complainant in response to a bidder that enters a bid into an auction and retracts the bid just prior to the close of the auction. Indeed, the bidder may be a competitor that is attempting to keep other bidders out by entering a high bid that discourages other bidding.

The unpaid item component process 202 is an automated dispute resolution process that may be initiated by a seller complainant in response to a buyer that has agreed to the terms of a transaction (e.g., auction, sale, etc.) but may not have, subsequent to close of the transaction, sent payment, responded to e-mail, or responded to telephone correspondence initiated by the seller.

### Buyer Initiated Complaints

The non-selling seller component process 204 is an automated dispute resolution process that may be initiated by a buyer complainant in response to a seller that refuses deliver of an item (e.g., good or service) after the buyer and seller have completed the transaction.

The item not received component process 206 is an automated dispute resolution process that may be initiated by a buyer in response to not receiving an item (e.g., good or service) for a significant time after the buyer and seller have completed a transaction.

The item received not as described component process 208 is an automated dispute resolution process that may be initiated by a buyer complainant in response to receiving an item not as described in the listing. Similarly, the item received significantly not as described component process 210 is an automated dispute resolution processes that may be initiated by a buyer in response to receiving an item significantly not as described in the listing. In one embodiment, the item received not as described component process 208 and the item received significantly not as described component process 210 may be combined into a single component process.

The return policy disputes component process 212 is an automated dispute resolution process that may be initiated by a buyer complainant in response to a seller that violates their own published return policy (e.g., a seller advertises a 30 day money back guarantee but later declines to accept a return of an item during this time frame).

### Seller or Buyer Initiated Complaints

The solution matching component process 214 is an automated dispute resolution process that may be initiated by a seller or buyer complainant to resolve a dispute. The solution matching component process 214 suggests solutions that may be implemented responsive to consent of the complainant and respondent. For example, a buyer complainant and a seller respondent may agree to immediately settle a dispute regarding a damaged item by the seller refunding the purchase price and the buyer returning the item. In other words, the solution matching component process 214 may ensure that obvious and straightforward solutions to the dispute have been explored. The solution matching component process 214 may present multiple solutions to the complainant who may elect one or more of the proposed solutions. The respondent may agree to any one of the proposed solutions to settle the dispute.

The monetary settlement component process 216 is an automated dispute resolution process that may be initiated by a buyer or a seller complainant to settle a dispute for money (e.g., the Cybersettle application developed by Cybersettle, of White Plains, N.Y.). In an example embodiment, the complainant and respondent may enter offers and demands that are received by the monetary settlement component process 216. The party seeking money in exchange for settlement of the dispute typically enters three demands (e.g., monetary amount) that decrease in value. The party paying money in exchange for settlement of the dispute typically enters three offers that increase in value. The monetary settlement component process 216 automatically compares the offers and demands round by round. If the offer and demand associated with a round are within a published range of settlement then the dispute settles. Otherwise the monetary settlement component process 216 proceeds to the next round. If all of the offers and demands are not within a range of settlement, then the monetary settlement component process 216 keeps the offer and demand amounts confidential, allowing the participants to utilize another component process 192 to settle the dispute without having prejudiced their positions

The mediation component process 218 may be a fully automated dispute resolution process that may be initiated by a buyer or seller complainant to settle a dispute with mediation services. The mediation component process 218 may be utilized to resolve any number of different types of disputes and uses a mediator that interacts with the disputants (e.g., email, videoconference, instant messaging, etc., combinations thereof) to resolve the dispute. The mediator may be a human being or an automated process. The mediator seeks to elicit from the disputants a mutually acceptable resolution to the dispute but has no power to impose a resolution on the parties.

The non-binding arbitration component process 220 may be a fully automated dispute resolution process that may be utilized by a buyer or seller complainant to settle a dispute with arbitration services. The non-binding arbitration component process 220 uses an arbitrator that interacts with the disputants to settle the dispute. The arbitrator may be a human being or an automated process. The arbitrator interacts with the disputants (e.g., email, videoconference, instant messaging, etc., combinations thereof) who present their respective cases including arguments, documents, testimony, and other persuasive evidence. The arbitrator deliberates on the proffered evidence and arguments to render a non-binding decision on the parties. In other words the complainant and respondent are not obliged to follow the decision of the arbitrator.

The arbitration component process 222 may be a fully automated dispute resolution process that may initiated by a buyer or seller complainant to resolve a dispute with arbitration services. The arbitration component process 222 may execute in the same manner as the non-binding arbitration component process 220; however, the arbitrator may render a binding decision on the complainant and respondent.

The feedback review component process 224 may be a fully automated dispute resolution process that may be initiated by a buyer or seller complainant to request an independent third party to review feedback. The independent third party may be a human being or an automated process. The complainant may initiate the request because the complainant believes that the feedback is unfair or unwarranted and wants to protect their reputation. In an example embodiment, a feedback score may be removed based on the decision of the third party. In another embodiment, the feedback score and comment may be removed.

The mutual feedback withdrawal component process 226 may be a fully automated dispute resolution process that may be initiated by a buyer or seller complainant to remove mutual feedback (e.g., complainant authored feedback on the respondent and respondent authored feedback on the complainant). In an example embodiment, a feedback score may be withdrawn (e.g., not available for public inspection) based on consent of the complainant and respondent. In another embodiment, the feedback score and comment may be withdrawn.

The escrow related disputes component process 228 is an automated dispute resolution process that may be initiated by a buyer or seller complainant to resolve a dispute involving the use of an escrow service. An escrow service may be a licensed and regulated company that collects, holds, and sends a buyer's money to a seller according to instructions agreed on by both the buyer and seller. For example, the buyer may receive and approve the item from the seller within an agreed time frame, and the escrow service may then send the payment to the seller.

The expert evaluation component process 230 is an automated dispute resolution process that may be initiated by a buyer or seller complainant to resolve a dispute with the aid of a third party who provides their personal, expert opinion as to a fair outcome to the dispute. The negotiation component process 232 is an automated dispute resolution process that may be utilized by a buyer or seller complainant to facilitate an exchange of messages between the parties with the intent of settling a dispute between them. The courtroom component process 234 is an automated dispute resolution process that may be utilized to initiate the community-based dispute resolution.

### Designing a Dispute Resolution Process

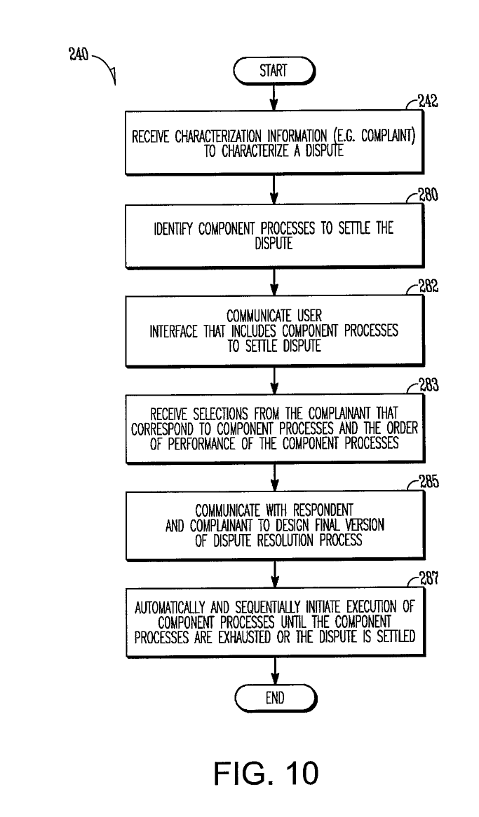

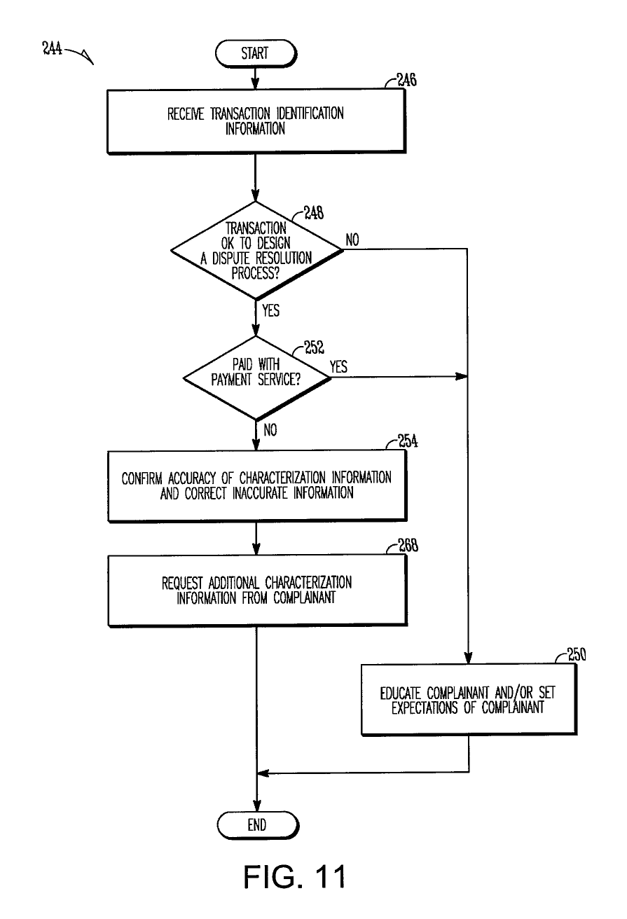

FIG. 10 is a flowchart illustrating an example method 240 to enable a complainant to automatically design a dispute resolution process from a plurality of component processes, according to an example embodiment. The method commences at operation 242 with the communicating module 188 at the network-based marketplace 12 receiving characterization information, from a complainant, that characterizes a dispute. FIG. 11 is a flowchart illustrating a method 244 that may be utilized to receive characterization information from a complainant at a client machine 20. At operation 246, the communicating module 188 may respond to a complainant's request to enter a complaint (e.g., characterization information) by communicating a user interface to the complainant that requests a transaction number 118. The communicating module 188 may use the transaction number 118 to identify a transaction associated with the dispute. In another example, the complainant may be viewing a user interface associated with a specific transaction. In this example, the communicating module 188 may infer the transaction number 118 from the user interface. In another embodiment, the communicating module 188 may request an item number 116 that may be associated with the transaction number 118 by utilizing the item table 94.

At decision operation 248, the processing module 190 determines if a dispute resolution process may be designed for the identified transaction. For example, the transaction number 118 provided by the complainant may not identify a known transaction. Indeed, a buyer may unwittingly enter a fraudulent transaction number that has been provided by a fraudulent seller (e.g., the seller monitors an auction for bidder that has lost an auction and telephones the bidder to sell the item to the seller and provide the fraudulent transaction number). In another example, a complainant may not be logged onto the network-based marketplace 12 under the correct identity. This problem may be corrected by the complainant logging off of the network-based marketplace 12 and logging back onto the network-based marketplace 12 under the correct identity. As a third example, the complainant may provide a transaction number 118 that identifies a transaction that may have been identified as fraudulent by the network-based marketplace. The network-based marketplace 12 may refuse the complainant's request to design a dispute resolution process to prevent negotiations with a fraudulent party. In such instances, the complainant may be directed to file a claim with the network-based marketplace 12 to recover a full or partial refund. If the processing module 190 determines that a dispute resolution process may not be designed for the identified transaction then a branch is made to operation 250. Otherwise a branch is made to decision operation 252.

At operation 250, the processing module 190 communicates a user interface to the complainant that indicates the complainant may not design a dispute resolution process. In addition, the user interface may include information that educates and informs the complainant as to what actions, if any, may be appropriate (e.g., file a claim, wait, contact law enforcement agency, sign off and back on under a different identify, etc.).

At decision operation 252, the processing module 190 determines if the transaction was paid for with a payment service. For example, if the transaction was paid for with a payment service, then the user is directed to resolve the dispute at the payment service because additional mechanisms may be available to the claimant to settle the dispute (e.g., freeze payment, etc.).

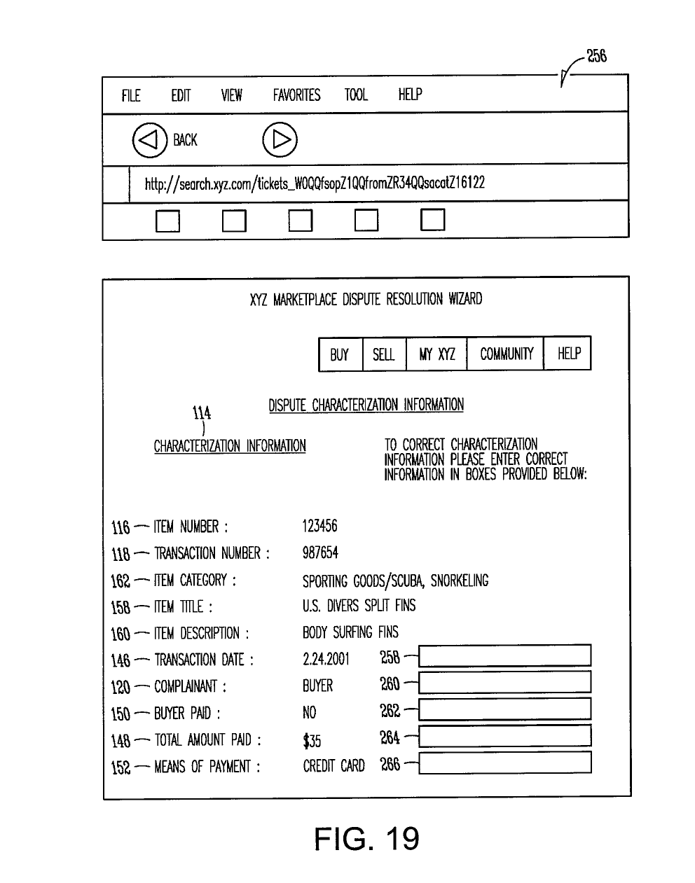

At operation 254, the processing module 190 communicates a user interface to the complaint to confirm the accuracy of the identified transaction information 140. FIG. 19 is a representation of a user interface 256, according to an example embodiment, to confirm the accuracy of characterization information. The user interface 256 is shown to include characterization information 114 that is associated with the transaction number 118 and text boxes to correct some of the characterization information 114. The characterization information 114 that cannot be corrected by the complainant includes an item number 116, a transaction number 118, an item category 162, an item title 158, and an item description 160. The characterization information 114 further includes a transaction date 146, a complainant 120, a buyer paid 150, a total amount paid 148, and a means of payment 152 that may be corrected by the complainant with text boxes 258, 260, 262, 264, and 266, respectively. The example user interface 256 is shown to include no corrections by the complainant.

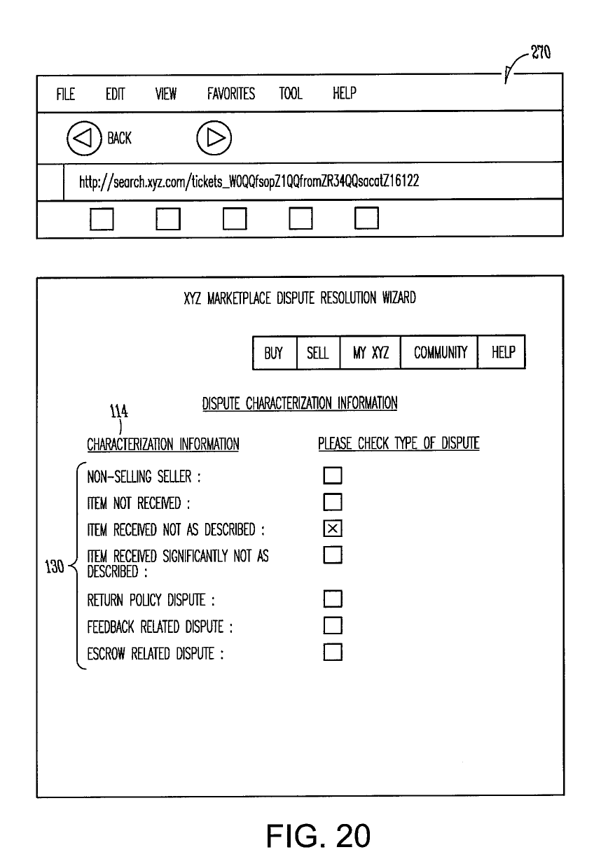

Returning to FIG. 11, at operation 268, the processing module 190 communicates a user interface to the complainant to request additional characterization information 114 from the complainant. FIG. 20 is a representation of a user interface 270, according to an example embodiment, to request additional characterization information. The user interface 270 is shown to include multiple dispute types 130 that may be selected by the complainant. The user interface 270 shows that the complainant has selected the “Item Received not as described” dispute type 130. In response, the processing module 190 may request additional characterization information 114.

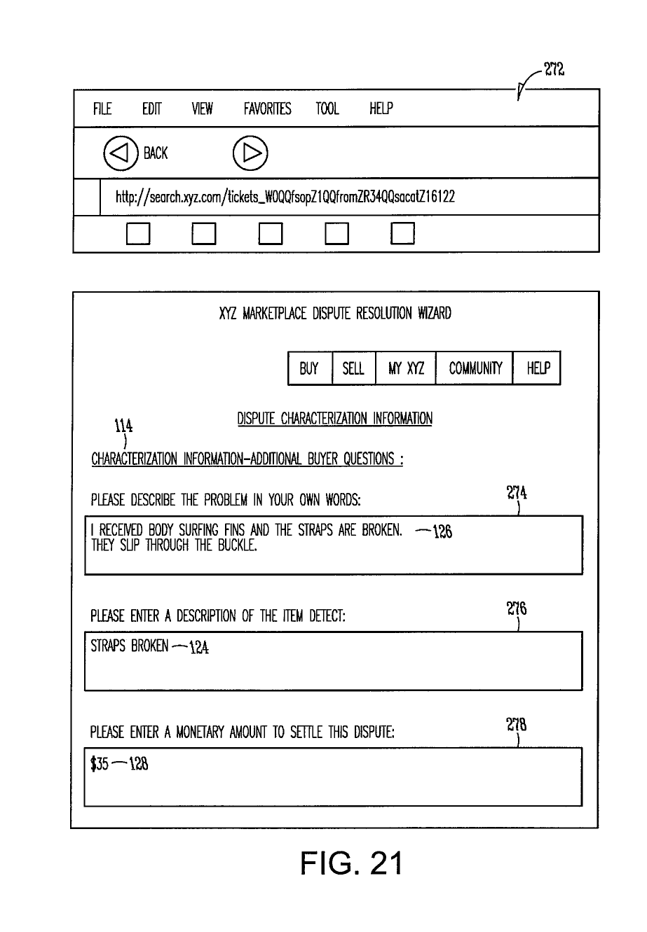

FIG. 21 is a representation of a user interface 272, according to an example embodiment, to request additional characterization information. The user interface 272 is shown to include characterization information 114 that includes text boxes 274, 276, and 278. The text box 274 may be used by the complainant to enter a complaint description 126. The text box 274 illustrates that the complainant has entered “I received body surfing fins and the straps are broken. They slip through the buckle.” The text box 276 may be used by the complainant to enter an item defect 124. The text box 276 illustrates that the complainant has entered “Straps Broken.” The text box 278 may be used by the complainant to enter a settlement amount 128. The text box 276 illustrates that the complainant has entered “$35”

Returning to FIG. 10, at operation 280 the processing module 190 uses the characterization information 114 to identify component processes 192 that the complainant may utilize to settle the dispute.

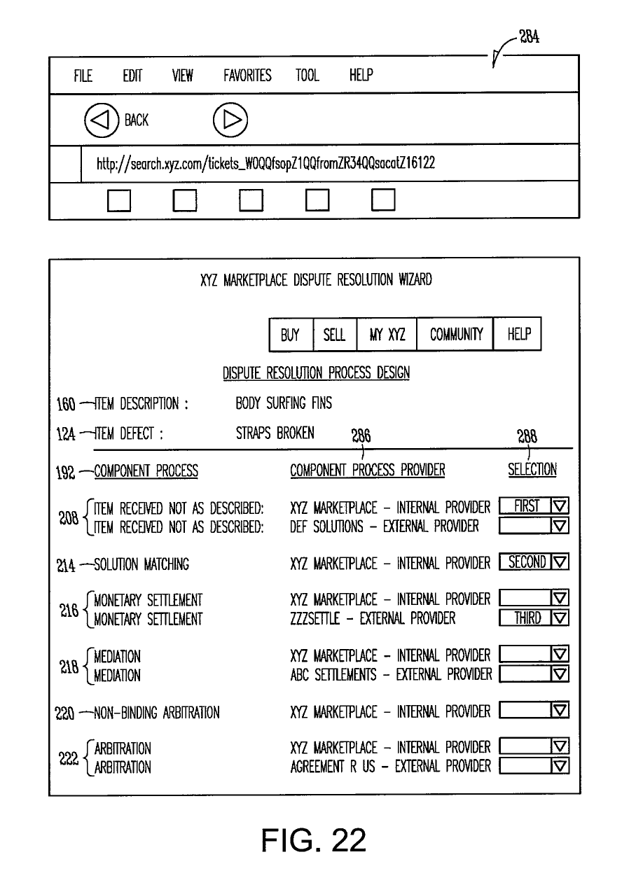

At operation 282, the processing module 190 communicates a user interface to the complainant at the client machine 20 that enables the complainant to design a dispute resolution process. FIG. 22 is a representation of a user interface 284, according to an example embodiment, to design a dispute resolution process. The user interface 284 is shown to include an item description 160, an item defect 124, component processes 192 that have been identified by the processing module 190 as appropriate or relevant to settling the dispute, corresponding component process providers 286, and corresponding pull down menus 288 (e.g., Selection). The item description 160 and item defect 124 characterize the dispute for which the complainant is designing the dispute resolution process (e.g., “Body Surfing Fins” and “Straps Broken”). It will be appreciated that other embodiments may include additional and/or different characterization information 114. The component processes 192 includes two “Item Received not as described” component processes 208, a single “Solution Matching” component process 214, two “Monetary Settlement” component processes 216, two “Mediation” component processes 218, a single “Non-Binding Arbitration” component process 220 and two arbitration component processes 222. Each component process 192 may be associated with a component process provider 286 that provides or performs the component process 192. The component process provider 286 may be an internal provider (e.g., network-based marketplace 12) or an external provider (e.g., payment system, dispute resolution provider, etc.). The pull down menus 288 may be used by the complainant to design a dispute resolution process by selecting one or more component process 192 and the order of execution of the component processes 192.

Returning to FIG. 10, at operation 283, the processing module 190 receives selections from the complainant that correspond to component process 192 and the order of performance or execution of the component processes 192. For example, the user interface 284 illustrates that the claimant has selected the item received not as described component process 208 provided by the “XYZ Marketplace” (e.g., an internal provider) to be performed first, the solution matching component process 214 provided by the “XYZ Marketplace” (e.g., internal provider) to be performed second, and the monetary settlement component process 216 provided by “ZZZSettle” (e.g., an external provider) to be performed third.

At operation 285, the processing module 190 may communicate messages to the respondent and complainant (e.g., email, instant messaging, etc.) and receive messages from the respondent and complainant to design or generate a final version of the dispute resolution process. For example, the processing module 190 may communicate a message to the respondent that requests consent from the respondent to the use the selections of the complainant (including the complainant's selected ordering of the component processes 192) to settle the dispute. For some disputes, the processing module 190 may immediately receive the respondent's consent thereby finalizing the dispute resolution process that the complainant originally designed. However, in other instances, multiple messages between the processing module 190 and the parties (e.g., respondent, complainant) may be required before designing or generating a final version of the dispute resolution process. Indeed, the final version may include a different set of component processes 192 and/or a different order of execution of component processes 192.

At operation 287, the processing module 190 uses the final version of the dispute resolution process to automatically and sequentially initiate execution of the component processes 192 until the component processes 192 are exhausted or the dispute is settled.

The technical advantages of a system that enables a complainant to automatically design a dispute resolution process may include a reduction in the processing load on a computer system and a reduction of network traffic on a network. For example, without the system described above a user may be required to view multiple user interfaces and manually identify the component processes that may be appropriate to settle the user's dispute. Further, without the system described above the user may be required to independently initiate component processes rather than relying on the dispute resolution wizard to automatically initiate component processes to settle the dispute.

### Enabling Access to Deliberation Information

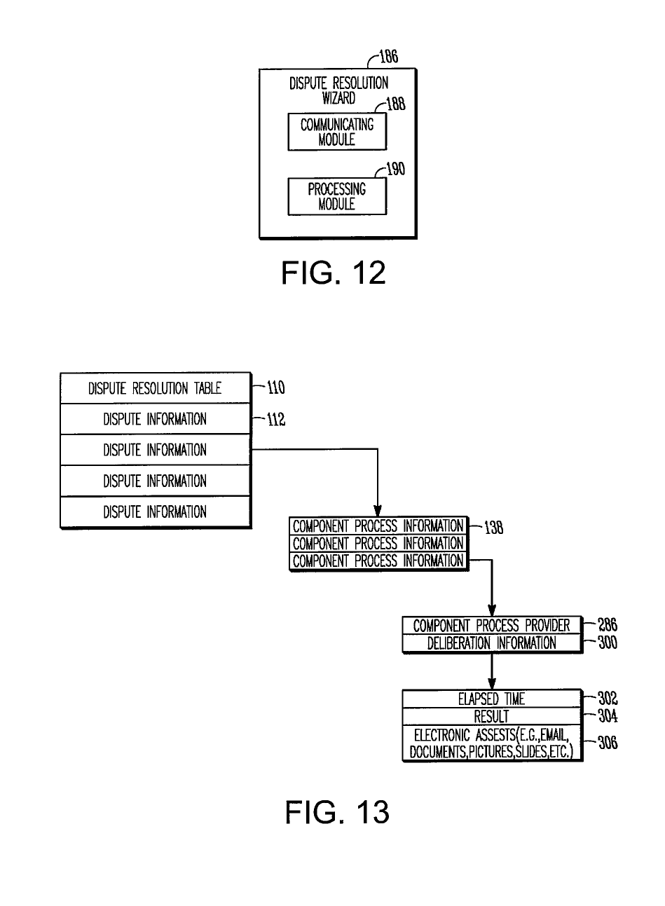

FIG. 12 is a block diagram illustrating a dispute resolution wizard 186, according to an example embodiment. The dispute resolution wizard 186 includes the communicating module 188 and the processing module 190. The communicating module receives characterization information 114 that may be used to characterize a dispute, as previously described. The processing module 190 utilizes the characterization information 114 to identify matching or corresponding disputes, generate user interfaces that include deliberation information associated with the matching disputes and communicates user interfaces to a user at a client machine 20 that enables the user to access deliberation information.

FIG. 13 is a block diagram illustrating a dispute resolution table 110, according to an example embodiment. The dispute resolution table 110 is used to store a dispute information entry 112 for each dispute. The dispute resolution table 110 is utilized as a knowledge database. For example, dispute information 112 is not purged off but rather stored for an indefinite period of time. The dispute information 112 may be entered by complainants and respondents who utilize the dispute resolution wizard 110 or uploaded from other databases that store the same, similar, or related information (e.g., case information including deliberation information that pertains to the resolution of disputes). Each dispute information entry 112 includes at least one component process information entry 138 that corresponds to a component process 192 that may have been utilized by at least one of the party's to settle the dispute. The component process information 138 includes a component process provider 286 and deliberation information 300. The component process provider 286 may be used to store provider information associated with the component process (e.g., internal provider—network-based marketplace 12, external provider—payment service, dispute resolution provider, etc.).

The deliberation information 300 includes an elapsed time 302, a result 304, and electronic assets 306. The elapsed time 302 may be used to store a measurement of time that has elapsed (e.g., days, hours, minutes, etc.) from the start of the execution of the component process 192 to the end of the execution of the component process 192. The result 304 may be used to store the result of the execution of the component process 192 (e.g., settled, not settled, settled in favor of buyer, settled in favor of seller, compromise, etc.). The electronic assets 306 may be used to store any type of digital media that may that may chronicle and/or document the deliberation of the parties during execution of the component process. For example, email exchanges between parties to the dispute or email exchanges between the parties and a third party (e.g., mediator, arbitrator, expert, etc.) or email exchanges with the component process 192 (e.g., instructions, educational information, directions, procedures, timelines, deadlines, termination dates, etc.), proffered evidence (e.g., documents, receipts, pictures, slides, illustrations, copy of the listing associated with the present transaction, user interfaces, web pages, interrogatories and responses thereto, testimony of witnesses and expert witness, etc.), presentation of arguments or reasoned thinking that facilitates resolution of the dispute (e.g., outlines, slides, synopsis, etc.), references or citations to persuasive or controlling authority (case citations, arbitration precedents, etc.), citations of procedures, guidelines, industry standards, etc (e.g., sellers return policy, industry standard terms, government policy regarding fair trading practices within an industry).

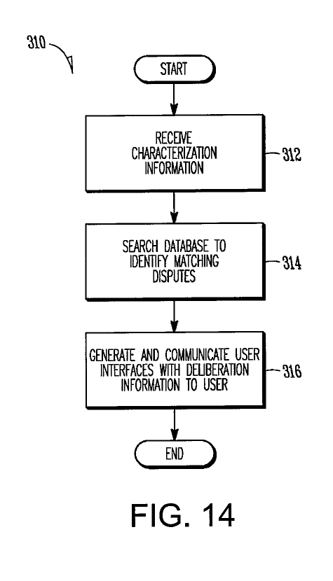

FIG. 14 is a flowchart illustrating a method 310 to enable access to deliberation information 300 associated with a second dispute to facilitate resolution of a first dispute, according to an example embodiment. The method 310 commences at operation 312 with the communicating module 188 receiving characterization information that may be entered by a user (e.g., complainant, buyer, seller, user, etc.) or retrieved from a database based on information provided by the user. The operation 312 has been previously described as the method 244.

At operation 314, the processing module 190 utilizes the received characterization information to search the dispute resolution table 110 and identify matching or corresponding dispute information 112 (e.g., corresponding disputes). It will be appreciated by those skilled in the art that the search for corresponding disputes may be performed by utilizing any number or combination of database searching technologies known to those in the art (e.g., fuzzy networks, case-based reasoning, evolutionary strategies, ARMA optimization, etc.). Further it will be appreciated by those skilled in the art that the characterization information 114 stored in the dispute resolution table 110 may be supplemented with metadata that structures the characterization information 114 and adds inferential information to the characterization information 114 to facilitate greater recall and more precise matching of disputes.

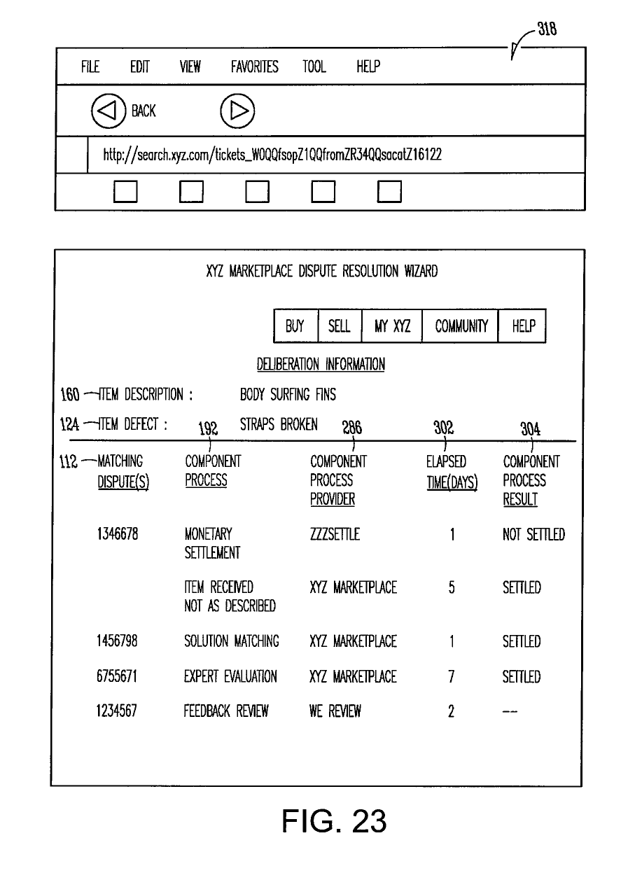

At operation 316, the processing module 190 generates user interfaces that include deliberation information 300 and communicates the user interfaces to the user. FIG. 23 is a representation of a user interface 318, according to an example embodiment, to enable access to deliberation information 300. The user interface 318 is shown to include an item description 160, an item defect 124, disputes 112, component processes 192, component process providers 286, elapsed time 302, and results 304. The item description 160 (e.g., “Body Surfing Fins”) and item defect 124 (e.g., “Straps Broken.”) characterize the dispute that the user is attempting to match. Each matching dispute 112 may be identified with a dispute number and may be associated with one or more component processes 192 that were utilized by at least one of the parties to the dispute in an attempt to settle the dispute. The component process provider 286 identifies the provider of the component process 192. The component process provider 286 may be an internal provider (e.g., XYZ Marketplace) or an external provider (e.g., ZZZSettle, WEReview, etc.). The elapsed time 302 is a measurement of time that has elapsed (e.g., days) from the start of the execution of the component process 192 to the end of the execution of the component process 192. The result 304 indicates the outcome of the component process 192 (e.g., settled, not settled, etc.). Each of the component processes 192 may be selected by the user at the client machine 20. For example, the user at the client machine 20 selects the “Expert Evaluation” component process 192 associated with the matching dispute 112 “675561” from the user interface 318 to review the corresponding deliberation information 300.

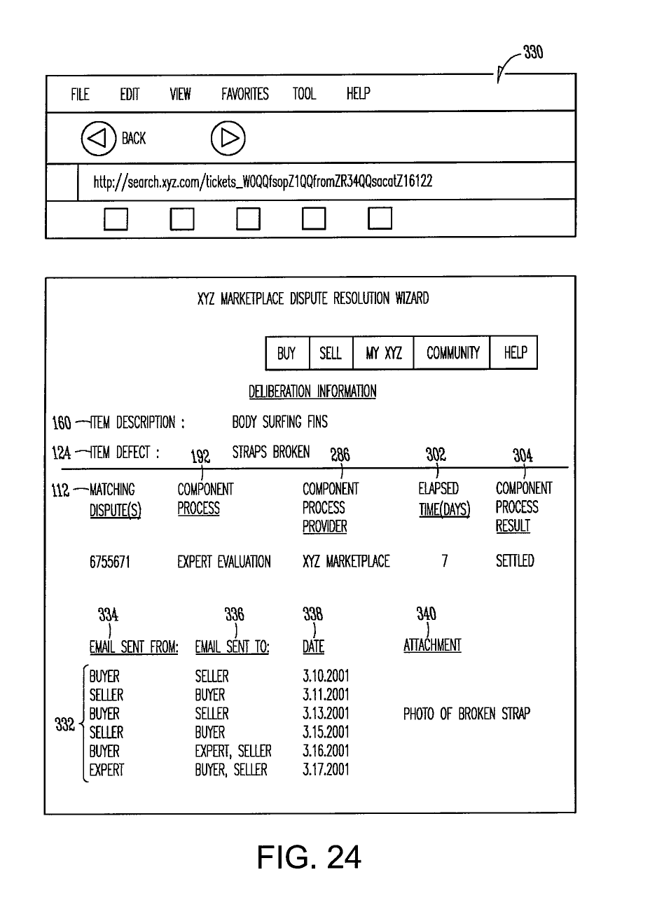

FIG. 24 is a representation of a user interface 330, according to an example embodiment, to enable access to deliberation information 300. Specifically, the user interface 330 is shown to enable access to deliberation information 300 associated with a previous selection from user interface 318 (e.g., dispute “675561”, “Expert Evaluation”). The user interface 330 is shown to include an item description 160, an item defect 124, disputes 112, component processes 192, component process providers 286, elapsed time 302, and results 304 that may be utilized to confirm the user's previous selection. The user interface 330 is further shown to include deliberation information 300 associated with the user's selection including a set of emails 332. Each email is associated with an originator (e.g., Email Sent From: 334), a recipient (e.g., Email Sent to: 336), a date 338 that the email was sent, and an optional attachment 340 (e.g., “Photo of broken strap”). The emails 332 are primarily exchanged between the buyer and seller; however one email originates with an Expert (e.g., dated Mar. 17, 2001) and is shown to be received by the Buyer and Seller. The user may select each of the emails to review their respective content and attachments, if any. For example, the user may select and review the following:
From: Buyer; To: Seller; Date: Mar. 10, 2001
Dear Seller: The Body Surfing Fins that you sent to me included broken straps. I would like a refund or replacement of the straps.
From: Seller; To: Buyer; Date: Mar. 11, 2001
Dear Buyer: I do not recall shipping any broken straps. Please describe the problem further.
From: Buyer; To: Seller; Date: Mar. 13, 2001
Dear Seller: Please see the attached photo. The straps are too narrow for the clasps. They will not cinch tight against my feet.
From: Seller; To: Buyer; Date: Mar. 15, 2001
Dear Buyer: These are the manufacturer provided straps for the fins. I suggest you contact the manufacturer.
From: Buyer; To: Expert, Seller; Date Mar. 16, 2001
Dear Expert: Please review our emails and provide an opinion regarding how we might resolve this dispute.
From: Expert; To: Buyer, Seller; Date Mar. 17, 2001
Dear Buyer and Seller: I have reviewed the emails you have exchanged, the listing describing the body surfing fins authored by the seller, and the photograph provided by the buyer. The seller has delivered a set of fins and straps that do not function as represented by the seller. The seller should refund the buyer's money or replace the straps.

The above described deliberation information 300 may help the users to understand their dispute. For example, a buyer may recognize the importance of accurately describing the problem and the value of a photograph in communicating the complaint to others. In addition, a seller may recognize that Experts hold sellers responsible for selling non-functional merchandise even if the problem may be traced back to a manufacturer.

The technical advantages of a system that enable access to deliberation information associated with a second dispute to facilitate resolution of a first dispute may include a reduction in the processing load on a computer system and a reduction of network traffic on a network. For example, without the system described above, a user may use non-optimal component processes to settle a dispute. In other words, enabling accesses to deliberation information associated with matching disputes may facilitate the discovery of an optimal approach to resolving the user's dispute thereby minimizing the utilization of computing and networking resources.

### Reviewing Component Processes

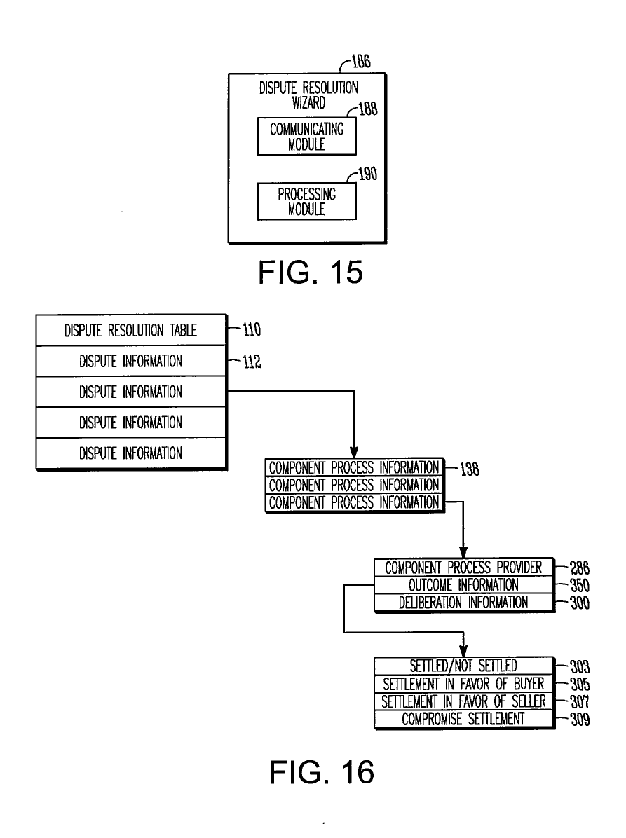

FIG. 15 is a block diagram illustrating a dispute resolution wizard 186, according to an example embodiment. The dispute resolution wizard 186 includes a communicating module 188 and a processing module 190. The communicating module 188 receives characterization information 114 that may be used to characterize a dispute as previously described. The processing module 190 utilizes the characterization information 114 to search a database to identify matching or corresponding disputes, retrieve component processes associated with the respective disputes, retrieve outcome information associated with the respective component processes, compute aggregate outcome information based on the outcome information, and communicate user interfaces to a user that include the aggregate outcome information.

FIG. 16 is a block diagram illustrating a dispute resolution table 110, according to an example embodiment. The dispute resolution table 110 may be utilized to store dispute information 112 including one or more component process information 138 entries, as previously described. The component process information 138 may be used to store outcome information 350 resulting from the execution of the corresponding component process 192. The outcome information 350 is shown to store a number of flags including a settled/not settled 303 flag (e.g., asserted may indicate the dispute was settled), a settlement in favor of buyer 305 flag (e.g., asserted may indicate the dispute was settled in favor of the buyer), a settlement in favor of seller 307 flag (e.g., asserted may indicate the dispute was settled in favor of the seller), and a compromise settlement flag 309 (e.g., asserted may indicate the dispute was settled with a compromise).

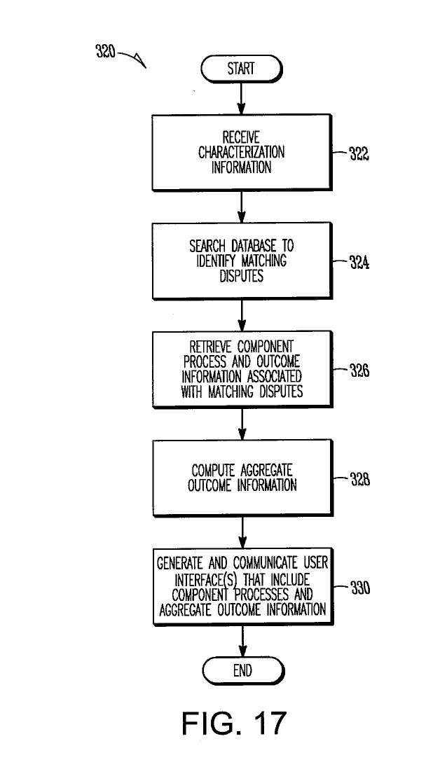

FIG. 17 is a flowchart illustrating a method 320, according to an example embodiment, to assist a review of a plurality of component processes 192 that may be respectively utilized to facilitate the resolution of a dispute. The method 320 commences at operation 322 with the communicating module 188 receiving characterization information that may be entered by a complainant at the client machine 20 or retrieved from a database based on information provided by the complainant. The operation 322 has been previously described as the method 244.

At operation 324, the processing module 190 utilizes the received characterization information to search the dispute resolution table 110 and identify matching or corresponding dispute information 112 (e.g., corresponding disputes).

At operation 326, the processing module 190 retrieves one or more component processes 192 (e.g., component process information 138) including outcome information 350 associated with each of the disputes.

At operation 328, the processing module 190 computes aggregate outcome information based on the retrieved outcome information 350. For example, the processing module 190 may compute settlement rates associated with matching disputes where the complainant and/or respondent used a particular component process 192 (e.g., Item Received Not as Described—XYZ Marketplace) in an attempt to settle the dispute. For example, the processing module 190 may compute a settlement rate 342, a settlement rate in favor of buyer 346, a settlement rate in favor of seller 348 and a compromise settlement rate 351 as follows:

| Settlement Rate | Computation |
|---|---|
| Settlement Rate | $\frac{Number of Matching Disputes that Settled}{Total Number of Matching Disputes}$ |
| Settlement Rate In Favor of Buyer | $\frac{\begin{matrix}Number of Matching Disputes that Settled in Favor \\ of Buyer\end{matrix}}{Total Number of Matching Disputes}$ |
| Settlement Rate In Favor of Seller | $\frac{\begin{matrix}Number of Matching Disputes that Settled in Favor \\ of Seller\end{matrix}}{Total Number of Matching Disputes}$ |
| Compromise Settlement Rate | $\frac{Number of Matching Disputes Compromised}{Total Number of Matching Disputes}$ |

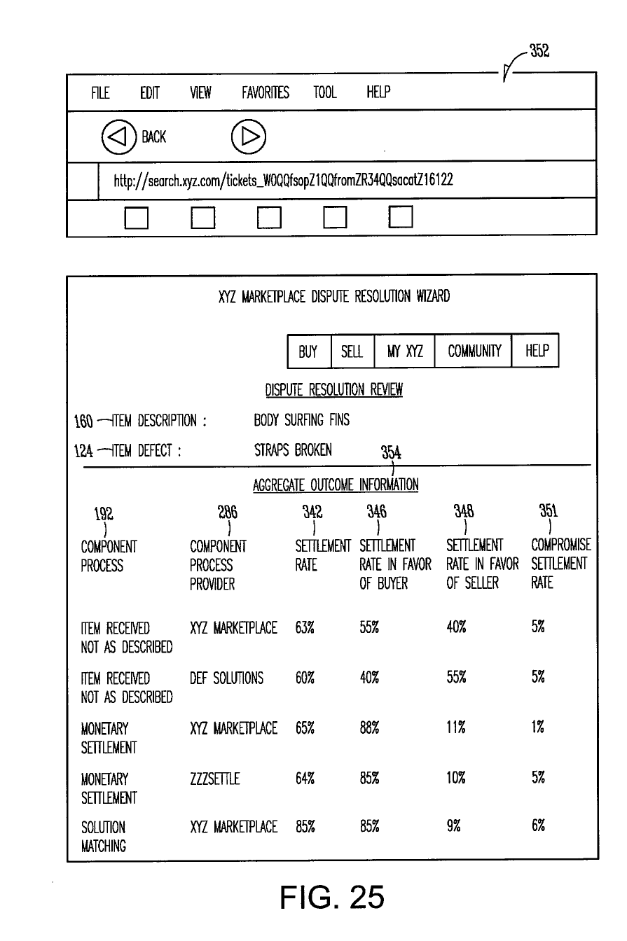

At operation 330, the processing module 190 generates user interfaces that include the aggregate outcome information and communicates the user interfaces to the user at the client machine 20 to assist the user in reviewing component processes that have been utilized to resolve matching disputes. FIG. 25 is a representation of a user interface 352, according to an example embodiment, to review aggregate outcome information. The user interface 352 is shown to include an item description 160, an item defect 124, and aggregate outcome information 354. The item description 160 and item defect 124 may be utilized to characterize the dispute that the user wants the dispute resolution wizard 186 to match. The aggregate outcome information 354 includes settlement rates that were computed based on matching disputes. Settlement rates are computed for each component processes 192 and include a settlement rate 342, a settlement rate in favor of buyer 356, a settlement rate in favor of seller 348, and a compromise settlement rate 351. The settlement rates for each component process 192 are computed based on outcome information 350 associated with matching disputes that utilized the particular component process 192.

The technical advantages of a system that assists a review of multiple component processes that are respectively utilized to facilitate the resolution of a dispute, may include a reduction in the processing load on a computer system and a reduction of network traffic on a network. For example, without the system described above a user may use non-optimal component processes to settle a dispute. In other words, assisting a review of multiple component processes may facilitate the discovery of an optimal approach to resolving the users dispute thereby minimizing the utilization of computing and networking resources.

### Resolution Center Embodiment

Another example embodiment of the above described invention includes a Resolution Center. An example embodiment provides a Resolution Center (e.g., status management application 184) that may increase customer satisfaction and decrease contact rates by providing users with a single area online for filing, checking on, and resolving all types of disputes and/or issues. To this end, functionality is provided so that users learn that any time they are involved in a complaint, chargeback, appeal, or similar situation, there is an online Resolution Center available on a website, and this Resolution Center is an effective portal to monitor and process all of their issues (e.g., issues/disputes they have initiated and issues/disputes to which they are responding).

### Overview:

In one example, the Resolution Center may be implemented as follows:
1. Add entry points to the network-based marketplace 12 for the Resolution Center
2. Provide users with a Resolution Center
   a. Includes an entry point to the buyer complaint filing process
   b. Includes an entry point to information about third party server 40 (e.g., payment machine) protection policies
   c. Relocate portions of the existing Limited Account Access Details page to the Resolution Center
      i. Relocate and reformat the ‘Required User Steps’ table
      ii. Relocate and reformat the ‘what can/can't I do when my account is limited’ content
      iii. Add an overall status for the account limitation/warning
3. Buyer Complaint flow improvements
   a. ‘Get Payment Machine Transaction ID’ process
   b. Payment Machine Buyer Protection partial refund process
   c. Provide on the seller's Complaint Detail page, the buyer's comments from the complaint filing process
4. Limited Account Access flow improvements
   a. Replace ‘to do’ checkboxes with a different UI element
   b. Improve the ‘Confirm location’ process
   c. Improve the ‘Confirm Social Security Number’ process
5. Flag in the database when a transaction may be subject to an ‘issue’ (e.g. complaint, chargeback, etc.)
6. Protection Policies page
   a. Provide users with a page that may have a short description of each Payment Machine protection policy and links to the more detailed policy pages
7. Security Center evolution
   a. Change Security Center links and contents to send users to relevant parts of the Resolution Center

### Messaging Application Embodiment

Another example embodiment of the above described invention includes a system to customize messages. An example embodiment provides a system that may increase customer satisfaction by improving communication between administrative agents and customers. The system provides administrative agents with a set of user interfaces that enable the manipulation of content in outgoing emails. One with ordinary skill in the art will recognize that other embodiments may utilize communication technologies other than email (e.g., web pages, instant messages, etc.). In an example embodiment, functionality may be provided so that an outgoing email may be characterized as automatic, optional, selectable, custom or free form.

An automatic email is communicated to a customer by a function without the intervention of an administrative agent. An optional email may not be sent to a customer based on a choice that is selected by an administrative agent. A selectable email may be characterized by an administrative agent that may select the email from one of several emails. A custom email may be characterized by an administrative agent that may select components of the custom email from a set of choices. For example, a custom email may include an agreement to end a dispute that may be sent to the disputants of the dispute. Such an agreement may include components of information (e.g., blocks of text, graphics, illustrations, etc.) that may have been selected by an administrative agent (e.g., a mediator, arbitrator, etc.) from a menu that includes a superset of components of information. A free form email is characterized by an administrative agent that may edit the contents of an email. In another embodiment, the administrative agent may automatically select a localized version (e.g., including the language) of an outgoing email based on the customer's country.

### Overview

The system to customize messages may allow the following methods for editing example outgoing emails from an administrator:
1. Automatic, in an example embodiment.
May be utilized when a function initiates one email that has all needed information
In an example embodiment, no agent choice or email preview is allowed
2. Optional, in an example embodiment.
May be utilized when a function initiates one email that has all needed information and may not be sent
In an example embodiment, the Optional method may allow the agent to send or not send the email, but no email editing or preview may be allowed
3. Selectable, in an example embodiment.
May be utilized when a function initiates one of several emails that have all needed information
In an example embodiment, the Selectable method may allow the agent to send one of several emails, but no email editing or preview may be allowed
In an example embodiment, the Selectable method may be combined with the Optional method to allow agent to send or not send one of several emails
4. Custom, in an example embodiment.
In an example embodiment, the Custom method may be utilized when a function initiates an email that does not contain all the needed information
In an example embodiment, the Custom method may be utilized to display a custom interface that may allow the agent to fill the needed information
In an example embodiment, only non-text data may be agent-entered. In an example embodiment text data must be selected from pre-set choices
In an example embodiment, the Custom method may be utilized to display a preview of agent selections before confirming, but does not allow direct editing
In an example embodiment, if the type of needed info changes, the custom interface must be updated

In an example embodiment, an administrator may automatically select the localized version of the outgoing email for the customer's country. In an example embodiment, some templates may be updated or created to prevent agent editing.

### Independent Feedback Review Embodiment

Another example embodiment of the above described invention includes a system to independently review feedback. An example embodiment provides for a system that receives a feedback from a buyer with regard to an incident (e.g., transaction of an item) involving a seller in a network-based marketplace. The feedback may include negative comments about the performance of the seller, which may be read by the seller, and other users of the network-based marketplace. The seller may protect his/her reputation by requesting a review that, upon a favorable finding for the seller, may result in withdrawing the feedback. To this end, the seller may communicate a complaint to the network-based marketplace. At the network-based marketplace, a customer support representative reads the complaint and identifies one of multiple independent reviewers (e.g., independent of the network-based marketplace and/or payment services) to review the incident and make a recommendation regarding withdrawal of the feedback. Preliminary to the review, the seller is provided an opportunity to more fully state the complaint, and the buyer is provided an opportunity to respond to the complaint. At an appropriate time, the reviewer reviews the feedback, the complaint, and the response to determine if the provided information is sufficient to make a decision regarding withdrawal of the feedback. If the provided information is not sufficient, the reviewer may request additional information. If the provided information is sufficient, then the reviewer may communicate a recommendation to the network-based marketplace. If the reviewer recommends that the feedback should be withdrawn then the customer support representative may utilize a mutual feedback withdrawal customer service tool to withdraw the feedback.

### Overview

In an example embodiment, the system may give users transacting in particular categories on network-based marketplace machine 12 the ability to put feedback comments through an Independent Feedback Review process. Users want a way to object to feedback that may be unwarranted. An example embodiment described below describes a way that users may “object” to a feedback comment.

In an example embodiment, the system to independently review feedback may increase user (e.g., customer) satisfaction in regards to feedback. Many users perceive that feedback may hurt their business due to unjust feedback comments. This embodiment allows users to place feedback comments through a review process that may determine if the feedback score is in fact unjust. Feedback may be one of the biggest complaints from sellers. Improving this experience may increase listings due to increased transaction satisfaction.

In an example embodiment, the system to independently review feedback may help users to understand the Independent Feedback Review (IFR) process before choosing to participate. An example embodiment may make the feedback withdrawal process and messaging as similar to Mutual Feedback Withdrawal as possible. The message that may be placed in the feedback forum may be as clear as possible to other users.

### Independent Feedback Review Process

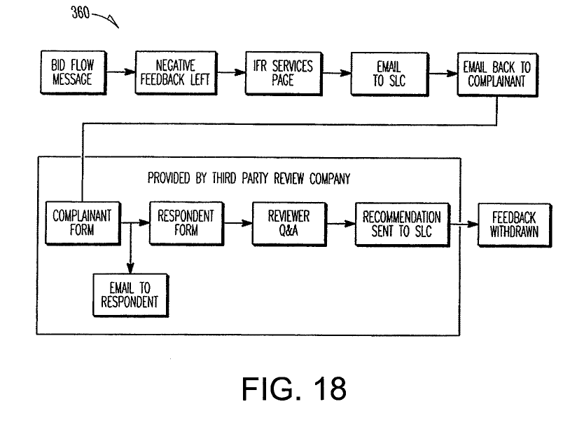

The Independent Feedback Review (IFR) process may be performed by customer support at the network-based marketplace 12 or by a third party (e.g., reviewer). FIG. 18 is block diagram illustrating a method 360 to independently review feedback. Described below is a general explanation of the method 360, according to an example embodiment. Sellers may not always be the ones asking for a review of a feedback comment (e.g., buyers, interested users, etc.), but since sellers may be expected to represent the vast majority of complainants, the below example may involve a seller complaining about a negative feedback comment.
1. A user places a bid and sees messaging in the bid flow that says feedback left for this item is subject to an independent feedback review process, according to an example embodiment.
2. A buyer leaves a negative feedback comment for the seller, according to an example embodiment.
3. The seller reads a services web page that explains the IFR process and decides to file a complaint, according to an example embodiment.
4. The seller files a complaint by sending a free text email to the network based-marketplace Customer Support, according to an example embodiment.
5. Customer Support reads the email and determines a reviewer that hears the complaint (e.g., SquareTrade, Better Business Bureau, and DeMars), according to an example embodiment.
6. Seller is sent an email with a link to a review hub web page that allows the seller 5000 characters to state his/her complaint, according to an example embodiment.
7. Buyer receives an email that says the seller has submitted a complaint, and the buyer may use their allotted 5000 characters to respond to the complaint, according to an example embodiment.
8. A reviewer looks at both sides and may determine if she has enough information to make a decision. If the answer is no, then she may ask for specific additional information, according to an example embodiment.
9. The reviewer then makes a recommendation to the network-based marketplace as to what should happen with the feedback comment, according to an example embodiment.
10. The recommendation comes to Customer Support at the network-based marketplace 12 so that Customer Support may take appropriate action, according to an example embodiment.
11. If the decision is that there is not be enough information to withdraw the feedback comment, then nothing may be done, according to an example embodiment. If the reviewer suggests that the feedback comment should be withdrawn, then a support representative utilizes a Mutual Feedback Withdrawal Customer Support Tool to withdraw the feedback, according to an example embodiment.

### Mutual Feedback Withdrawal Customer Support Tool

### Review and Confirm User Interface

The Review and Confirm web page in the Mutual Feedback Withdrawal Customer Support Tool may be the web page that allows the support representative to choose which feedback comment, or comments, on the transaction to withdraw, according to an example embodiment. This web page may also allow the support representative to choose the reason for withdrawal. This web page may receive only the following changes, according to an example embodiment:

A new “Reason for withdrawal” may be added in the form of a radio button that may be labeled: “Independent Feedback Review”

A user interface may include a feedback comment that is selected for withdrawal and a “Mutual Agreement” that is selected as a reason for withdrawal, according to an example embodiment.

### Confirmation User Interface

In an example embodiment, upon entering submit, comments that are marked for withdrawal may be withdrawn within 2 hours:
The comment may be marked as withdrawn in the database, according to an example embodiment.
A distinct feedback type may be used for each of the new withdrawal reasons, according to an example embodiment.
An eNote may be filed for the member(s) who may have had feedback withdrawn from their profile, according to an example embodiment.
The Subject may be: Feedback Withdrawal within the General Support major type, according to an example embodiment.
The content may include the item number, the buyer ID, the seller ID, the withdrawal date, and the withdrawal reason, CSR's userid, according to an example embodiment.

When feedback is withdrawn, a note may be left on both the buyer and seller's account, according to an example embodiment.

### Scoring

Every comment that has been withdrawn may be displayed throughout the feedback system, according to an example embodiment.
This includes the member profile page (e.g., displaying a member profile) including the All tab, buyers, and from sellers tabs; live auctions, all international sites, the reply process, the follow up process, My Account, etc., according to an example embodiment.
A withdrawn comment may not have any designation of the original rating. It may appear icon less as shown in the figure below, according to an example embodiment.
Withdrawn comments may also have a system message appended to the bottom of the comment (and any reply or follow up) that reads “Withdrawn: An independent reviewer determined this comment to be inconsistent with feedback policy guidelines. Learn more”, according to an example embodiment.

### Item Not Received/Item Significantly Not as Described Embodiment

Another example embodiment of the above described invention includes a component processes 192 to process an Item Not Received and to process an Item Significantly Not as Described, as described below. In an example embodiment, disputes over items not received or received but significantly not as described may usually be resolved by direct communication between buyers and sellers. To facilitate resolution, the Network-Based Marketplace 12 may provide an online process where buyers and sellers may communicate with each other. In an example embodiment, an Item Not Received or Significantly Not As Described policy and User Agreement may both state that sellers may deliver the items that buyers purchase from them.

Typically, there may be five stages in the Item Not Received or Significantly Not as Described Process, according to an example embodiment:

Stage 1: Buyer files an Item Not Received or Significantly Not as Described dispute. Buyers files an Item Not Received or Significantly Not as Described dispute between 7 and 45 days after the transaction date (the date when the buyer commits to buying the item and the seller commits to selling it). When filing, the buyer may indicate whether the item may not have been received or whether it may have been received but significantly not as described.

Stage 2: XYZ Network-Based Marketplace contacts the seller. Once a dispute is filed, the network-based marketplace 12 may contact the seller and informs them of the dispute.

Stage 3: The seller responds. The seller is presented with several response options to communicate with the buyer.

In an item not received dispute, the seller may respond:
I've already shipped the item—if the item may have been shipped, the seller may provide shipping details for the buyer to review.
I'll offer a full refund—the seller may offer to return all of the buyer's money.

In an item significantly not as described dispute, the seller may respond:
I've shipped a replacement item—if the seller has shipped a replacement item, they may provide shipping details for the buyer to review.
I'll offer a refund—the seller may offer a full or partial refund to the buyer to attempt to resolve the dispute.

For all disputes the seller may respond:
I would like to communicate with the seller—the seller may then be able to post a message for the buyer to review.

Stage 4: Communication between the buyer and seller. The buyer and seller attempt to resolve the dispute by continuing to communicate directly through XYZ Network-Based Marketplace's online process.

Stage 5: Closing the dispute. The buyer may close the dispute at any point after the seller has responded, or if the seller does not respond within 10 days. The buyer has two options to close the dispute:
My concerns may have been resolved. With this option, no action may be taken against the seller's account and the buyer may not be eligible to file a claim under network-based marketplace 12 standard purchase protection program. A closed dispute may not be re-opened, so the buyer may want to be sure that they may be entirely satisfied before they decide to close a dispute using this option. For example, if the buyer is offered a full refund by the seller, they may not close the dispute until they have received the full refund.
I no longer wish to communicate with or wait for the buyer. When the buyer selects this option, XYZ Network-Based Marketplace's Trust and Safety team may be immediately alerted about the transaction. If warranted, the seller's account may be restricted or suspended. If the buyer closes the dispute with this option and the transaction is eligible, then the buyer may file a claim under XYZ Network-Based Marketplace's standard purchase protection program, where they may be reimbursed up to $200 (minus a $25 filing fee).

A dispute may only be open for 60 days after the transaction date. If the buyer has not closed the dispute within 60 days, it may be automatically closed. When a dispute may be automatically closed, the seller may not be reported to XYZ Network-Based Marketplace's Trust and Safety team and the buyer may not be eligible to submit a claim under XYZ Network-Based Marketplace's Standard Purchase Protection Program.

Feedback and Item Not Received or Significantly Not as Described disputes. Buyers and sellers may leave feedback for each other on transactions involving Items Not Received or Significantly Not as Described disputes. XYZ Network-Based Marketplace encourages all users to leave appropriate feedback about their trading partners. Participating in the Item Not Received or Significantly Not as Described process does not automatically affect a user's feedback score or member profile.

### Unpaid Item Embodiment

Another example embodiment of the above described invention includes a component process 192 to process an Unpaid Item (UPI) as described below. An example embodiment may provide for a system that processes a dispute with regard to an item (e.g., item or service) transacted (e.g., via an auction, purchase, etc.) in a network-based marketplace 12 (or any other commerce system) between a buyer and a seller. Subsequent to the close of the transaction (e.g., close of auction, agree to purchase, etc.), the buyer may not send payment or respond to e-mail or telephone correspondence originated by the seller. To facilitate resolution, in an example embodiment, a network-based marketplace 12 may provide an online dispute resolution component process 192 to process the dispute. Other embodiments may include a payment system or third party to facilitate the online dispute resolution process.

In an example embodiment, the UPI component process focuses on improving communication between the buyer and seller; streamlining a Final Value Fee (FVF) credit process; and making it easier for sellers to manage UPI disputes.

In an example embodiment, two types of disputes may be filed including a dispute where a buyer has not paid or refuses to pay and a dispute where both the buyer and seller have agreed not to complete the transaction. If an example embodiment, a payment system that indicates item is paid (and not refunded) will preclude the filing of an UPI dispute.

Buyer Has Not Paid
Seller must wait 7 days before filing, according to an example embodiment
No waiting period if buyer is not a registered user (NARU) or from a country that seller does not ship to, according to an example embodiment
In these special cases, FVF credit may be given immediately, according to an example embodiment.

Buyer and Seller Have Agreed Not to Complete the Transaction
No waiting period to file this type of dispute, according to an example embodiment
Immediate FVF credit if buyer may be NARU, according to an example embodiment
If buyer agrees within 7 days, FVF credit may be given to the seller, according to an example embodiment
If buyer disagrees, no FVF credit may be given, according to an example embodiment
If buyer does not respond in 7 days, seller may request their FVF credit, according to an example embodiment.

### Mutual Agreement Buyer Check

In an example embodiment, sellers may be informed that the buyers may be required to confirm mutual agreement. Confirmation may act as a check against fraudulent FVF refund requests.

### Mutual Agreement Confirmation

Once buyers confirm, the FVF may be refunded. If they do not confirm, no FVF refund may be given.

### Disputes Console

The disputes console may integrate all member disputes, according to an example embodiment. The view may be for both buyers and sellers.

### Buyer Response Options

Example buyer responses include:
“Pay Now”,
“I have already paid.”
“I would like to pay for this item, but I have a concern that needs to be resolved first.”

### Seller Response Options

“We've completed the transaction and we're both satisfied.”
“We've agreed not to complete the transaction or the buyer is returning the item.”
“I no longer wish to communicate with or wait for the buyer.”

### Seller Remove Strike

In an example embodiment, sellers may later remove strikes if they change their minds.

### Miscellaneous Embodiments

Another example embodiment of the above-described inventions includes a dispute dashboard or console for online dispute resolution (ODR) system administrators and ODR neutral providers (e.g., provides mediators, arbitrators, facilitators, etc.) with up-to-date statistics on the number of open disputes, closed disputes (both resolved and unresolved), cases awaiting neutral response/buyer response/seller response. The console may also include controls to manage disputes, manage workflows, and automatically disposition certain cases.

Another example embodiment of the above-described inventions includes a Case Management System. The Case Management System may automatically and dynamically allocate neutrals (e.g., arbitrators, mediators, etc.) to disputes thereby forming cases. The neutrals may be allocated from multiple Online Dispute Resolution (ODR) providers that screen for and provide specialized neutrals. (e.g., a motor specialist may be allocated to a motor dispute, etc.). The allocation system may utilize criteria to assign disputes to neutrals. The criteria may be generated in response to cultural reasons, language constraints, dispute types, panelist requirements, etc. In an example embodiment, the Case Management System may allocate a neutral to a dispute based on facts that characterize the dispute and the neutral's profile (e.g., arbitrator profiles, mediator profiles, etc.). In another embodiment, the Case Management System may include a strike process where both sides may list multiple neutrals (e.g., arbitrators, mediators, etc.) that may be compared for a matched neutral signaling acceptance to both sides thereby triggering an allocation of the neutral to the dispute. In another embodiment, both sides may review each other's list and strike a neutral based on a perceived conflict of interest.

Another example embodiment of the above-described invention includes a Case Management System where neutrals can see all of their active cases, the status of each case, and cases that require immediate attention. The Case Management System may enable a neutral to rank their assigned cases according to a priority that signifies which case requires attention first. In another embodiment, the Case Management system may monitor the nature of a communications between parties or the nature of communications between a party and the Resolution Center (e.g., content of the emails, instant messages, etc.) to identify a case that requires intervention by the neutral (e.g., the parties are becoming belligerent). For cases identified as such, the Case Management system may notify the neutral accordingly. In another embodiment, the Case Management system may identify a case as requiring intervention by the assigned neutral based on message velocity (e.g., the posting a number of emails, instant messages, etc. within a predetermined period of time) as measured between parties or between a party and the Resolution Center.

In another embodiment, the Case Management System may include a time-delimited case management mechanism that updates available buyer and seller actions. At any given moment, the actions or options available to a buyer or seller may be determined based on buyer and seller characteristics (e.g., feedback, dispute history), time elapsed, previous actions taken by the two parties, and previous actions available to but not taken by the parties.

In another embodiment, the time delimited case management mechanism may include a dynamically generated calendar with key dates and deadlines, automatically generated at dispute inception, and updateable by the disputants, the neutral, and case administrators.

In another embodiment, the Case Management System may include a Fraud Evaluation System that includes a language analysis tool that may examine messages exchanged between buyer and seller to classify a dispute as to a specific type and to diagnose whether a case may be determined as potentially fraudulent.

In another embodiment, the Fraud Evaluation System may dynamically track dispute/complaint filings and establishes account limits and/or suspensions for accounts based on risk assessments or scores generated from that information. For example, a fraud-scoring matrix may be utilized to signal the severity of a fraud event and the suggested actions that may be taken against or on behalf of the involved buyer or seller. The algorithm may monitor mistakes (e.g., a case that is determined to be fraudulent but not detected) and adjust their predictions accordingly.

Another example embodiment of the above-described invention includes a system to automate a seal program. For example, certification may be posted by a user to certify that the user has pre-committed to use specific dispute resolution processes in the case of a dispute.

Another example embodiment of the above-described invention includes a system that generates a feedback rating and tracks the number of disputes a user has been involved in, how many were resolved amicably, and comments from the other party about the behavior of the user.

Another example embodiment of the above-described invention includes deliberation information that includes agreement text from disputes that have been resolved or settled. In an example embodiment, identifying information may be removed to protect the privacy of the parties.

Another example embodiment of the above-described invention includes a system that performs automatic language translation for the parties/participants in a dispute resolution. For example, the complainant may want to communicate in English, the respondent may want to communicate in Spanish, and the mediator may want to communicate in German. The system may perform simultaneous and automatic language translation to facilitate settlement of the dispute.

Another example embodiment of the above-described invention includes a system that disputants may use to automatically negotiate payment terms and automatically pay for the filing of a dispute in a manner that is transparent to the neutral (e.g., mediator, facilitator, arbitrator, expert, etc.). Transparency may ensure that the neutral is not biased by a sense of obligation to one party or the other based on their funding of the neutral's services. In other words, the system precludes a biasing of the neutral by preventing the neutral from perceiving who is paying the bill or who may be paying a larger percentage of the bill. For example, in an example embodiment all payment may be made to a pool that is allocated out among providers which, in turn, reallocates payment to the neutrals (e.g., panelists, mediators, etc.).

Another example embodiment of the above-described invention includes a case management process or system in which neutral, third-party administrators may communicate with the disputants to find out the nature of their dispute, what has already occurred, and to offer advice about next steps or processes.

Another example embodiment of the above-described invention includes a solution suggestion mechanism, where disputants may consult a database of solutions and choose the solution they would prefer. For example, a user may log in and present their problem. In response, the system may search a database to identify common solutions to the problem and communicate to the user a user interface that includes the common solutions and requests the user to indicate which of the common solutions the user would accept. Next, the system may contact the other party and indicate the common solutions that were chosen and request the other party to select to one or more of the common solutions to resolve the dispute. The system may become smarter over time as innovative solutions are stored in the database. In an example embodiment, actual language from other disputes or settlement agreements may be stored.

Another example embodiment of the above-described invention includes a component process 192 that facilitates an automated exchange of monetary proposals between disputants with conditions associated with each proposal. For example, the tool may require both sides to enter a predetermined number (e.g., three) of monetary bids (e.g., offers and demands) and conditions. If for example, one party's monetary demand number one and the other party's monetary offer number one are within a predetermined percentage (e.g., 30%), and the parties further reach agreement with regard to associated conditions then the tool may settle the dispute. If the bids are not within the predetermined percentage or the conditions are not mutually satisfactory, then the tool may go to a second round of negotiation (e.g., bid number two, condition set two) without disclosing the bids or conditions. For example, party A may offer to pay $50 to settle the dispute but only if party B does X, Y, and Z. Further, if none of the rounds result in settlement then the parties exchange no information. For example, the parties maybe apart by $1,000 or maybe apart by $10 but the only information disclosed is that the parties missed settlement.

Another example embodiment of the above-described invention includes a component process 192 that facilitates automated negotiation by using a rules engine that automatically evaluates complaints/filed disputes and renders decisions based on pre-specified parameters.

Another example embodiment of the above-described invention includes a component process 192 that facilitates automated negotiation whereby high volume sellers may program an agent (e.g., automated robot) that may respond on the seller's behalf to disputes filed against the seller. For example, the agent may offer a refund in response to a dispute that meets a certain profile (e.g., refund amount less than $10, etc.).

Another example embodiment of the above-described invention includes a component process 192 that facilitates automated negotiation whereby disputants or parties may automatically strike proposed third party neutrals (e.g., mediators, arbitrators, experts, etc.) to arrive at one or more mutually acceptable third party neutrals.

Another example embodiment of the above-described invention includes a component process 192 feedback system to rate the performance of particular neutrals so that future parties can make an informed decision about which neutral(s) they should select for their dispute resolution process.

Another example embodiment of the above-described invention includes a language library that may be consulted by third party neutrals (e.g., mediators, arbitrators, experts, etc.) for useful terms or phrases submitted by other neutrals.

Another example embodiment of the above-described invention includes a caucus tool that enables confidential communications. For example, the caucus tool may provide the ability for a neutral to communicate with one party in a separate space in addition to a joint space where the parties and the neutral communicate together. The tool may further provide for a caucus space where a party may interact and strategize with his or her “counsel” (supporters or advocates) without fear that others may be able to see what they are saying.

Another example embodiment of the above-described invention includes a neutral review tool that allows a neutral to approve each submitted message before it is posted into the message thread viewable by the other side.

Another example embodiment of the above-described invention includes an agreement drafting tool that may be used by neutrals to compose agreements for review by the disputants. For example, a neutral that is resolving a case between a German customer and a Chinese customer may pick components (e.g., in English) that are pretranslated into other languages (e.g., German, Chinese, etc.) that may be read by the disputants.

Another example embodiment of the above-described invention includes a proposal editing tool that tracks edits made to a proposed agreement so that changes may be stepped through stage by stage, with the author of each change indicated clearly.

Another example embodiment of the above-described invention includes a system by which both of the disputants may acknowledge and agree to abide by a specific proposal, either through electronic signatures or other means.

Another example embodiment of the above-described invention includes a language analysis tool that may examine messages (e.g., email, etc.) that may be exchanged between a buyer and a seller and responsive to the examination classify dispute types and diagnose cases that may indicate a high risk for fraud based on the language in the messages.

Another example embodiment of the above-described invention includes a tool that dynamically tracks dispute/complaint filings and institutes account limits and/or suspensions for accounts based on risk assessments or scores generated from that information. For example, the tool may utilize a fraud scoring matrix that indicates the severity of a fraud event and suggested or automatic actions that may be taken against or for the involved buyer or seller.

Another example embodiment of the above-described invention includes a fraud evaluation system by which a third party case evaluator may ask questions of disputants and render a decision on the severity of a particular case.

Another example embodiment of the above-described invention includes a dynamic jury convening, empanelling, and processing tool. For example, the tool may automatically notify users (e.g., community members) that they have been randomly selected to participate in a jury, prompt them to fill out an information form (e.g., the equivalent of showing up for jury duty), and then perform a strike process to select the jury. Further, the tool may include a mechanism by which juries may determine their unanimity or lack thereof in rendering a decision in a particular case, and then communicate that decision back to the judge and/or disputants. Further the tool may include a public participation (“gallery”) function that enables users to observe a dispute resolution process but not participate in the process.

Another example embodiment of the above-described invention includes an online courtroom tool that facilitates automatic and structured communication processes that approximate the rules in a face-to-face courtroom (e.g., the ability to object and be overruled, swear in witnesses, submit documents into evidence, and address the jury). In addition, the tool may be used to analyze the structured communications to automatically render decisions and grant relief. The structured communication may be embodied as email, instant messaging, voice, voice transcribed to text, video conferencing, etc.

Another example embodiment of the above-described invention includes an automated system for capturing, archiving, and indexing decisions in case evaluations/arbitrations so that future arbitrators can search the past decisions within a specific context and use the precedent of those cases in deciding future matters. For example, the system may dynamically capture the cases (e.g., outcomes) and then index the cases instantaneously into a library. Future case resolvers (e.g., mediators, arbitrators, experts, customer service representatives, etc.) may search the library and request everything related to a specific type of dispute (e.g., items delivered significantly not as described disputes) in a specific context (e.g., stamps).

Another example embodiment of the above-described invention includes an automated system for checking for panelist (e.g., jury) conflicts of interest (e.g., the panelist has decided cases for related parties in past cases). For example, the system may check all the past cases for a neutral and to determine whether the neutral decided cases that may be within the social network of the prospective party or prior business partners of the prospective party or prior transaction partners of the prospective party. The system may be used to prevent neutrals from handling cases where they were a mediator either for the prospective party before or mediated for other transaction partners for the prospective party.

Another example embodiment of the above-described invention includes a document submission system (“e-docket”) that accepts document submissions from the disputants. In an example embodiment, the document submission system may accept document submissions from the disputants in a particular order or on a particular schedule. Further, the document submission system may enable review of each document only by particular roles (neutral, party A, party B, etc.). For example, all the documents that a party submits may be visible to the party and their counsel, all the documents the other party submits may be visible to them and their counsel, and an evaluator may be permitted to view documents submitted by both parties. Further, the document submission system may enable document viewing by third parties who may submit information (e.g., a letter of authenticity, etc.) that may be visible to one or both parties depending on the identity and/or role of the person submitting the letter.

Another example embodiment of the above-described invention includes a case evaluation engine that may be used by a neutral (e.g., arbitrator, mediator, etc.) to evaluate a case by applying a set of predefined rules to the case. For example, an example embodiment of the tool may be used to counsel arbitrators in their deliberations. Another embodiment of the tool may be used by a party that may want to see how their case may work out. For example, the party may use the evaluation engine to receive an evaluation of their case without a binding decision. The party may enter all their data and the evaluation engine may process the data to a probable result (e.g., you win, you lose, etc.).

Another example embodiment of the above-described invention includes a decision drafting tool that may walk a panelist through drafting of each discrete component of a well structured decision and then compiles, formats, and submits the decision to both parties for their final approval and/or notification.

Another example embodiment of the above-described invention includes a system that may proactively initiate online dispute resolution based on predefined criteria (e.g., fraud prediction). For example, the system may monitor communications (e.g., parsing language in the communications) and proactively issue warnings to users or compel users into online dispute resolution if the communications contain information that matches predefined criteria.

Another example embodiment of the above-described invention includes a system to automatically void a complaint based on seller's proof. For example, a seller may automatically cancel a dispute based on proof provided by the seller to the system.

### Formation of an Online Dispute Resolution Environment

For some example embodiments, an electronic or online dispute resolution environment may be used to resolve the disputes among parties (e.g., the buyer and the seller). This environment may be viewed as an electronic or network-based courtroom where disputes can be resolved using computers coupled together in a network. A dispute resolution process along with associated applications, engines, and modules may reside in one or more servers in the network. The disputants may sign in to the one or more servers using a client computer. These dispute resolution applications and modules may include database management applications, disputant user management applications, the juror selection module 194, the panel module 195, the dispute fee management module 196, the decision module 197, the juror performance (evaluation) module 198, and so on. Any combination of these applications and modules may be embodied within the courtroom engine 193 and/or the dispute resolution applications 169, for example. It is noted that, since the dispute resolution environment is network-based, the disputants may be located in similar or in various geographical locations.

The disputes may be related to transactions entered into by the parties. The disputes may encompass any subject matters in which the parties are involved. For some embodiments, disputes may be resolved by one or more members of an electronic or online community. For example, a member may serve as a judge, and that member resolves the disputes based on information provided by the parties of the disputes. Alternatively, a jury that includes multiple jurors with each juror being a member of the community may resolve the disputes. The electronic or online courtroom may be referred to herein as a community court.

The jurors may be grouped based on their preferences. For example, in an ecommerce or electronic marketplace environment, some jurors may prefer to review disputes relating to automobiles while other jurors may prefer to review disputes involving books or antique items. For some embodiments, the community court may be associated with the electronic or online marketplace and its sole purpose is to resolve the disputes associated with that electronic marketplace. Alternatively, the community court may be an independent entity, and its purpose is to resolve disputes from various sources including electronic or non-electronic sources (e.g., offline marketplaces). It is also noted that a fee may be charged to have the community court resolve the disputes. Different fee arrangements are described in more details below.

In example embodiments, the disputants (e.g., a seller and a buyer in a sale transaction) may use the community court as an appeal medium from other dispute resolutions. For example, the dispute may initially be resolved by a staff of a dispute resolution department of the online marketplace. If the result decided by the staff is not acceptable by either or both disputants, either or both disputants may appeal to the community court.

### Dispute Interface

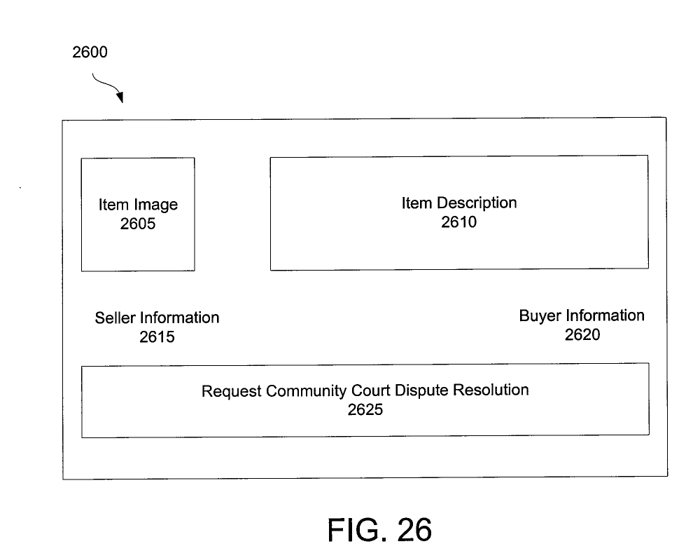

In example embodiments, a user interface is provided to enable the disputants to request the community court to resolve their disputes. FIG. 26 illustrates an example of a user interface, referred to herein as a disputant interface, in accordance with some example embodiments. Interface 2600 may include an image 2605 of an item in dispute and a description 2610 of the item. The interface 2600 may also include areas for the disputants to describe their views of the disputes. This is illustrated in FIG. 26 as seller information 2615 and buyer information 2620. The interface 2600 further includes a selector 2625 to request the community court to resolve the dispute. Although not shown, the interface 2600 may also include other information related to the item in dispute such as, for example, the price information, delivery information, condition information, quantity information, photographs, and other evidentiary information, etc.

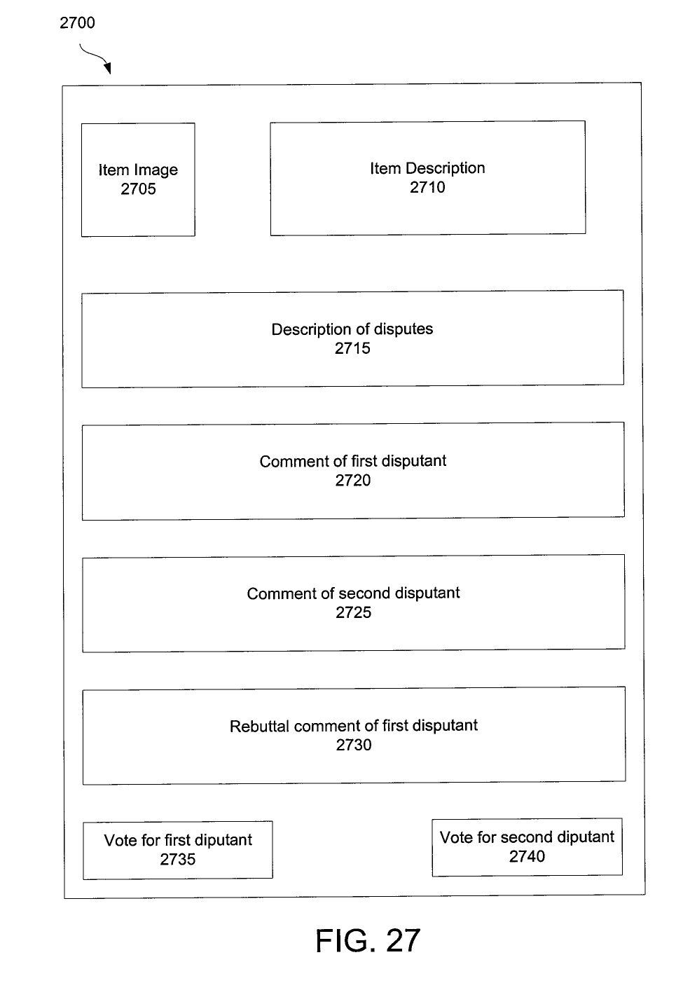

FIG. 27 illustrates an example of a user interface, referred to herein as a juror interface, in accordance with example embodiments. Interface 2700 may include an image 2705 of an item in dispute and a description 2710 of the item. The interface 2700 may further include a description of the dispute 2715, comments from the first disputant 2720, and comments from the second disputant 2725. It is assumed that a dispute involves two disputants or two groups of disputants, and the first disputant or the second disputant may refer to one disputant or a group of disputants.

In some example embodiments, the first disputant may also have the opportunity to provide a rebuttal based on the comments of the second disputant. This is illustrated as rebuttal comments 2730. When the juror has the opportunity to review all the information presented in the juror interface 2700, the juror may then vote in favor of the first disputant or the second disputant. This voting action may be performed by selecting one of the voting selectors 2735 and 2740. In some embodiments, a juror may have a limited period of time to vote. For example, a maximum length of time (e.g., 5 minutes) is allotted for a juror to provide the vote. This may enable resolution of the dispute in a timely manner.

### Jury Selection

In example embodiments, the jurors of the community court may comprise members of a marketplace for which the community court is intended to resolve the disputes. Initially, the potential juror may be invited based on some general criteria such as, for example, the length of time that the juror is a member of the community, the profession of the potential jurors (e.g., as indicated in their user profiles), the willingness to volunteer as the potential jurors (e.g., as indicated by their responses when registering as a member). Other juror invitation criteria may also be used.

The selected jurors may volunteer to vote on as many cases as they like. Alternatively, in order to provide a wider opinion and participation of the members of the community, a selected juror may only be allowed to vote on a limited number of disputes within a certain time period. For example, the limit may be voting on three disputes per week, one hundred disputes per year, etc.

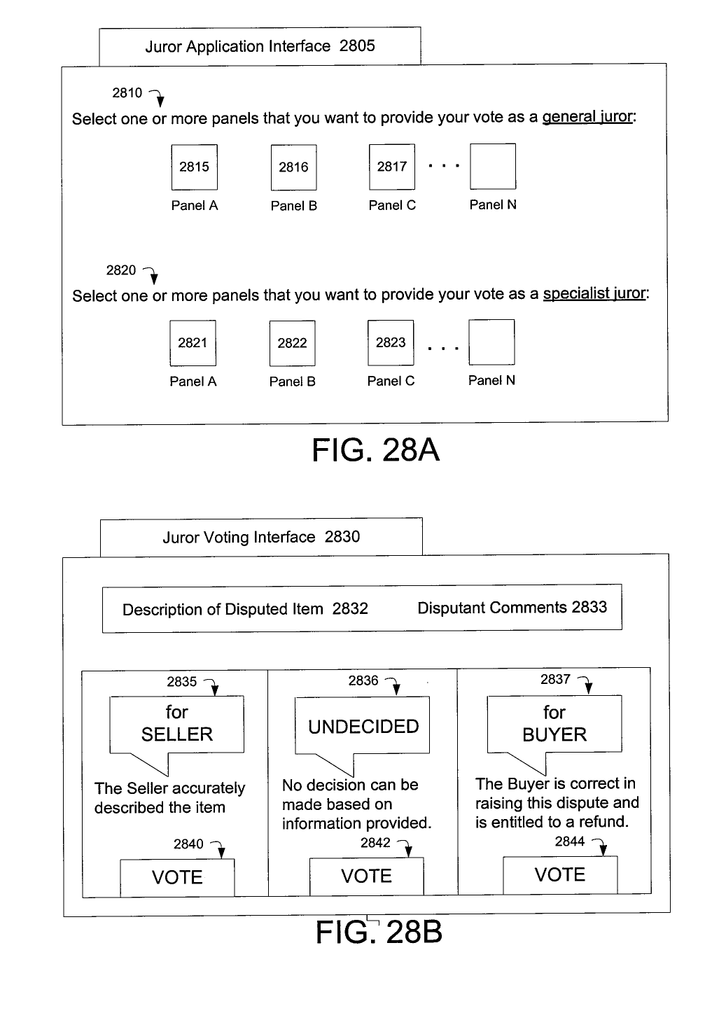

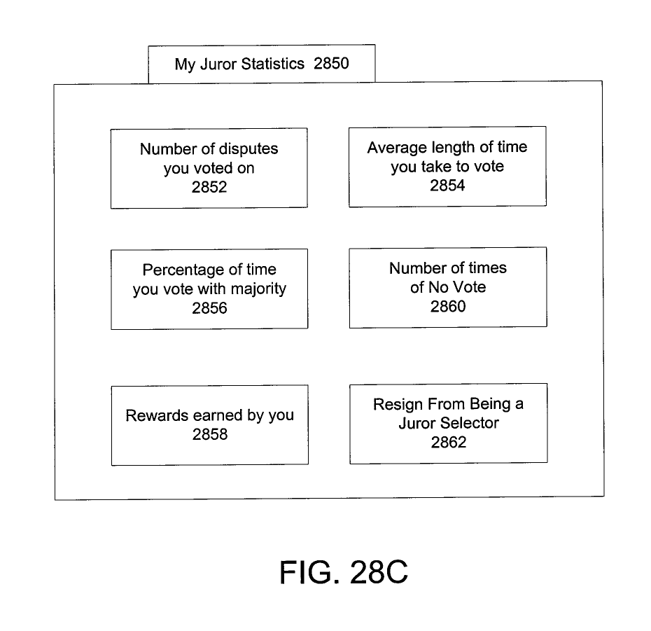

FIG. 28A illustrates a user interface, referred to herein as a juror application interface, in accordance with some example embodiments. Potential jurors may apply or volunteer to become a juror by responding to a set of questions pertaining to how they want to serve. The questions may relate to fields or topics in which the jurors may prefer to serve or participate. For some embodiments, there may be multiple panels defined according to the fields or topics. Each panel may include a defined number of jurors. A juror may serve in one or more panels. Furthermore, the jurors associated with a panel may serve as primary jurors or backup jurors. Referring to FIG. 28A, a potential juror may use the selectors 2815-2817 to select the panels.

In some embodiments, a juror may serve as a general juror or a specialist juror. A specialist juror is an individual who has a certain level of expertise in a field (e.g., more than a general juror). As illustrated in FIG. 28A, the juror may use the selectors 2821-2823 to serve as a specialist juror. The juror selection process may perform verification to confirm whether a potential juror is qualified to serve as a specialist juror. For example, the potential juror may be asked to provide additional information to confirm his or her credentials and qualification. The number of jurors in a panel of general jurors may be different from a number of jurors in a panel of specialist jurors (also referred to as an expert panel). In this arrangement, a specialist juror may serve as a judge when that juror is the only juror in a panel of specialist jurors.

As will be discussed, fees associated with having a dispute resolved by a panel of specialist jurors may be different from that of a panel of general jurors. In example embodiments, the disputants may select to have their disputes resolved by a panel of general jurors or by a panel of specialist jurors.

### Voting Interface

FIG. 28B illustrates an example of a user interface, referred to herein as a juror voting interface, in accordance with some embodiments. The voting interface 2830 may include information about a disputed subject matter 2832 and comments by the disputants 2833. The information about the disputed subject matter may include an image, if applicable, and a description of the disputed subject matter. After the juror (general or specialist) reviews the information 2832 and 2833, the juror may proceed to decide the outcome of the dispute. The juror may choose options 2835, 2836, or 2837 to vote for the first disputant (e.g., seller), to vote for neither disputant, or to vote for the second disputant (e.g., buyer), respectively. Based on the juror's decision, one of the vote selectors 2840, 2842, and 2844 may be activated. In some embodiments, decisions by a panel of jurors (general or specialist) may be based on a majority of votes. As such, the number of jurors in a panel may be determined to enable a majority vote to occur for each dispute resolution (e.g., an odd number of jurors on the panel).

### Juror Performance

FIG. 28C illustrates an example of a user interface, referred to herein as a juror performance statistic interface, in accordance with some embodiments. To enable fairness and to prevent abuse, a juror may be continuously monitored and evaluated to determine whether that juror continues to exhibit an ability to provide an un-biased and fair judgment. A set of criteria may be used to monitor performance of the jurors to determine their qualification to remain as jurors. In example embodiments, the set of criteria may include one or more of a length of time that a juror takes to make a decision (illustrated as 2854), whether the juror's decision is more often the decision of a majority of the jurors resolving the same dispute (illustrated as 2856), how often the juror fails to provide a vote within the allotted time (illustrated as 2860), and the number of disputes the juror voted on (illustrated as 2852). Other criteria may also be used to determine the performance of the juror. A juror who fails to meet one or more of the performance criteria within a time period (e.g., fails two times in a week), based on frequency (e.g., fails more than five times), or both may be asked to resign from serving as a juror. In example embodiments, a juror may have the option of voluntarily resigning from serving as a juror (illustrated as 2862). Furthermore, a reward feature (illustrated as 2858) may be used for each juror based on their performance or participation in resolving disputes. Each of the features illustrated in FIG. 28C may be implemented as a separate module in the dispute resolution process.

### Dispute Result Interface

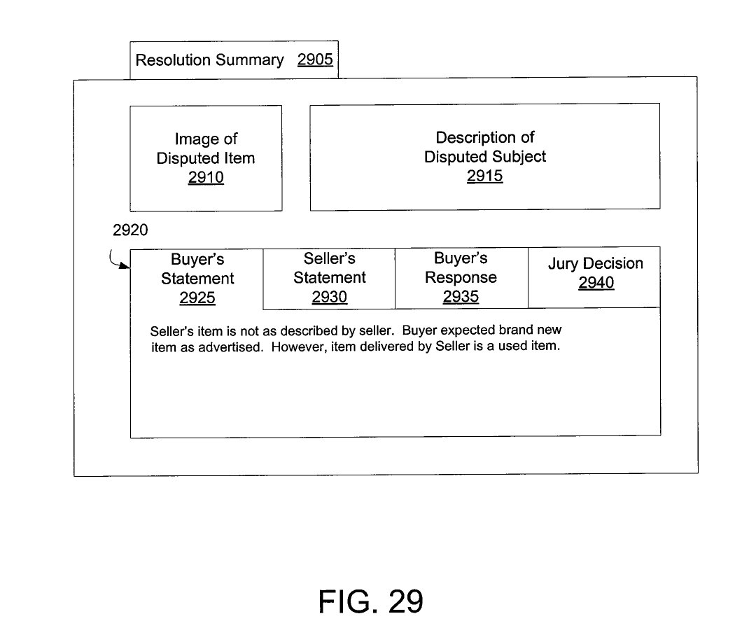

FIG. 29 illustrates an example of a user interface, referred to herein as a dispute result interface, in accordance with example embodiments. Interface 2905 may enable the disputants to review the status of disputes in which the disputants are involved. The interface 2905 may include some or all of the information related to the dispute including, for example, image 2910, description of the dispute 2915, and the statements of disputants 2925-2035. The dispute result interface 2905 also includes information about the decision of the jurors in resolving the dispute. This is illustrated as selector 2940. When a dispute is not yet resolved, the selector 2940 may be associated with a dispute resolution pending indicator.

### Dispute Summary Interface

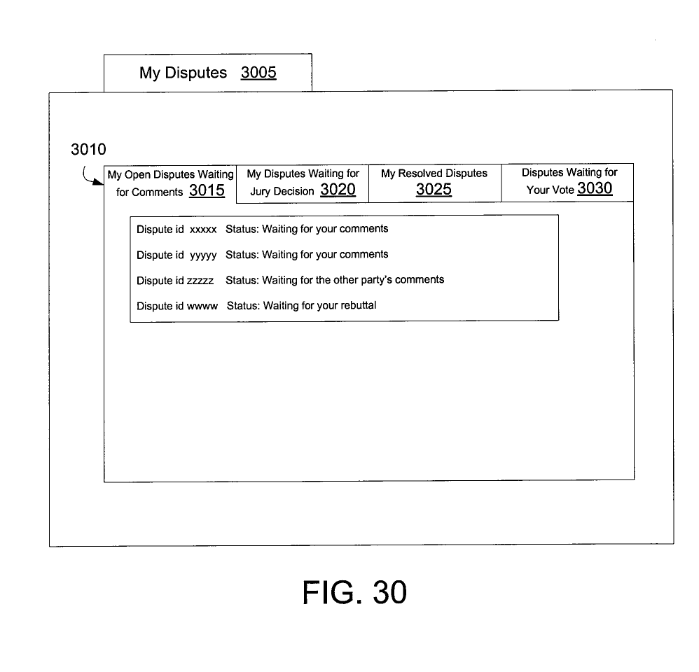

FIG. 30 illustrates an example of a user interface, referred to herein as a dispute summary interface, in accordance with example embodiments. A disputant may be involved in multiple disputes. Some disputes may have been resolved while one or more other disputes may be pending. A dispute summary interface 3005 provides a mechanism for the disputant to keep track of these disputes and how the disputes are resolved. The dispute summary interface 3005 includes status of each dispute in terms of waiting for comments (illustrated as 3015), waiting for decision by the jurors (illustrated as 3020), and disputes that have been resolved (illustrated as 3025). Further, since the disputant may also participate in the dispute resolution environment as a juror, the dispute summary interface 3005 may also include a selection 3030 to indicate whether there are pending disputes that are waiting to be voted on.

### Dispute Resolution Fees

In example embodiments, a fee may be charged to the disputants to have their disputes resolved by the jurors in one of the panels. The fee may be higher when the disputants agree to use specialist jurors. The fee may be collected by the entity that manages the dispute resolution environment. For some embodiments, a portion (percentage or flat) of the fees may be shared with the jurors in the form of rewards using a reward pool. The reward pool may be increased each time the entity collects fees from the disputants. The jurors are then rewarded from the reward pool based on their performance. Note that the reward to the juror may not be based purely on whether the juror votes for the first disputant or the second disputant. This prevents the jurors from favoring certain voting trends that may enable them to control their rewards. For example, a juror who fails to vote in a dispute is not measured equally to a juror who votes in the same dispute, even though a fee is collected from the disputants.

In an example within a marketplace environment, the disputant who initiated a dispute resolution is a seller. This may occur because the seller received a negative feedback from a buyer, and a request for a dispute resolution may protect the seller's reputation and rating. In some embodiments, a fee is charged to the seller when a dispute is initiated by the seller. For example, the fee may be $10.00. When a dispute is resolved in favor of the seller, at least a portion of the fee may be returned to the seller. No fee is charged to the buyer. However, if the result of the dispute resolution is not favorable to the seller, the fee is not returned to the seller. Instead, this fee is kept by the entity that manages the dispute resolution process and a portion may be rewarded to the jurors, as described above. In example embodiments, the reward may not be in the form of money but in the form of coupons, free services, etc. Since the reward is based on the juror's performance, the juror cannot control the reward by voting against the sellers just for the purpose of forcing the sellers to pay the fees. Other scenarios may be used in the collection and return of fees (e.g., a buyer pays the fee if initiating the dispute).

### Process

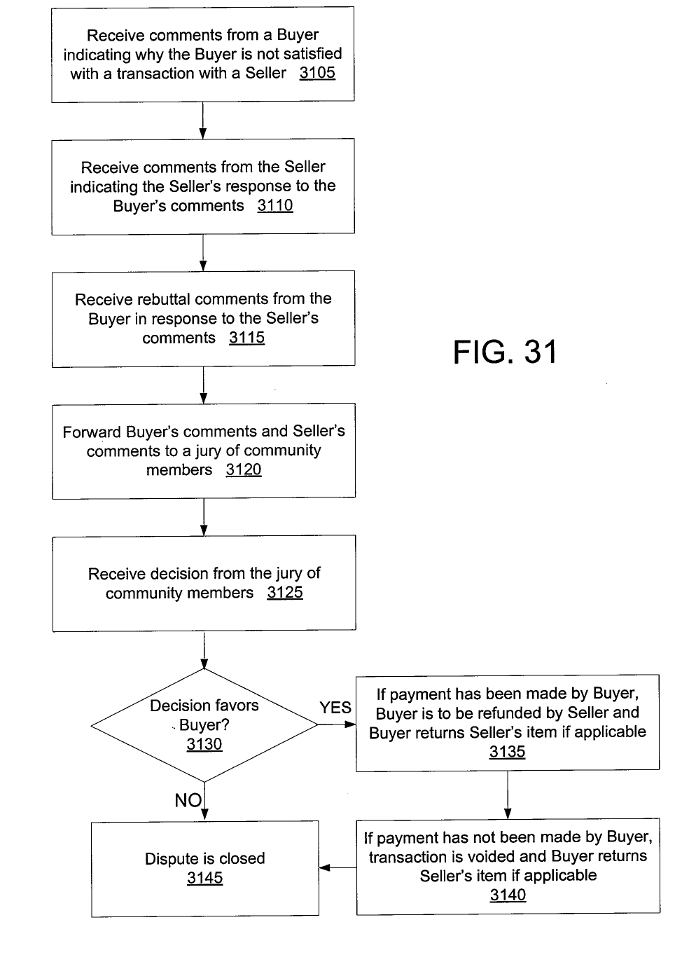

FIG. 31 illustrates an example of a method 3100 that may be used to resolve a dispute. The method may be performed by executing software instructions using one or more processors associated with a system that implements the dispute resolution applications. The process starts at block 3105 where a complaint is raised by a first disputant (e.g., a buyer) regarding a service or an item from a second disputant (e.g., a seller). In the present example, at block 3110, the seller provides a response to the buyer's comments. At block 3115, the buyer may provide a response to the seller's comments. At block 3120, the comments (e.g., evidence) are forwarded to a jury panel for review. When a decision is made by the jury panel, the decision is communicated to the seller and the buyer, as shown in block 3125.

At block 3130, a determination is made if the decision favors the buyer or the seller. If the decision favors the buyer, the seller refunds to the buyer any money, if money has already been paid by the buyer. Alternatively, if the money has not been paid, the buyer is allowed to rescind the purchase, as shown in block 3135. When applicable, the subject of the dispute is to be returned to the seller, as shown in block 3140. The dispute resolution ends at block 3145. From block 3130, if the decision favors the seller, the seller keeps the money and the buyer is not allowed to give the buyer a negative rating. The dispute resolution is completed.

The above example covers a situation when the buyer initiates the dispute resolution. In some embodiments, the method of FIG. 31 is modified to enable the seller to be the initiator of the dispute.

### Modules, Components, and Logic

Additionally, certain embodiments described herein may be implemented as logic or a number of applications, modules, engines, components, or mechanisms. An application, module, engine, logic, component, or mechanism (collectively referred to as a “module”) may be a tangible unit capable of performing certain operations and configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Computer System

Thus, a method and system to provide a community-based dispute resolution process have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

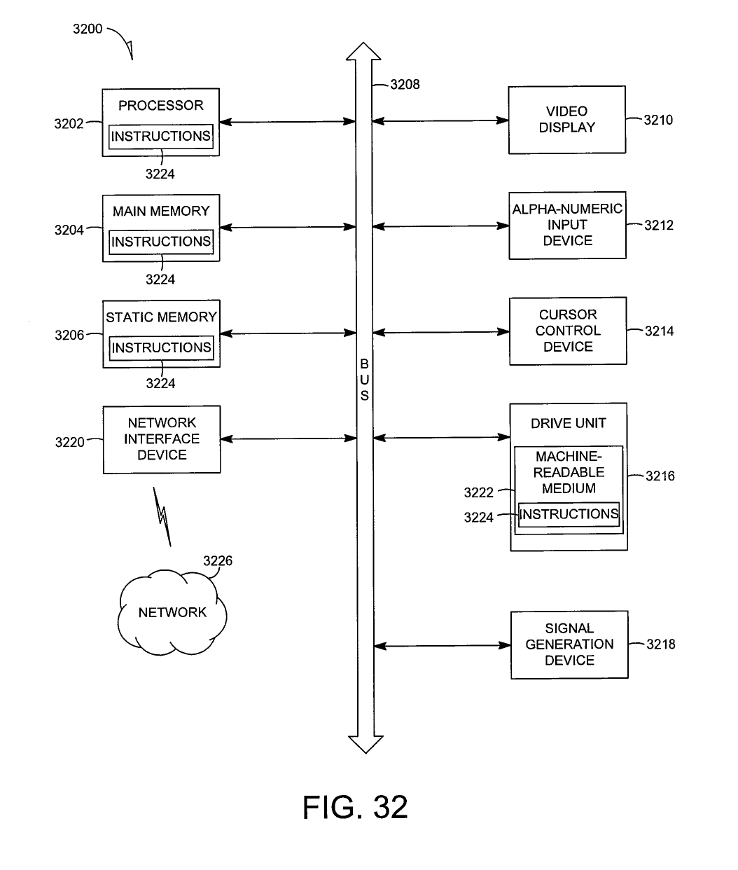

FIG. 32 shows a diagrammatic representation of machine in an example form of a computer system 3200 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 3200 includes a processor 3202 (e.g., a central processing unit (CPU) a graphics processing unit (GPU) or both), a main memory 3204 and a static memory 3206, which communicate with each other via a bus 3208. The computer system 3200 may further include a video display unit 3210 (e.g., a liquid crystal display (LCD) or a cathode ray tube (CRT)). The computer system 3200 also includes an alphanumeric input device 3212 (e.g., a keyboard), a cursor control device 3214 (e.g., a mouse), a disk drive unit 3216, a signal generation device 3218 (e.g., a speaker) and a network interface device 3220.

The disk drive unit 3216 includes a machine-readable medium 3222 on which is stored one or more sets of instructions 3224 (e.g., software) embodying any one or more of the methodologies or functions described herein. The instructions 3224 may also reside, completely or at least partially, within the main memory 3204 and/or within the processor 3202 during execution thereof by the computer system 3200, the main memory 3204, and the processor 3202 also constituting machine-readable media. The instructions 3224 may further be transmitted or received over a network 3226 via the network interface device 3220.

While the machine-readable medium 3222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

What is claimed is:

1. A method for community-based dispute resolution, the method comprising:
receiving a request to resolve a dispute within a network-based community from a first disputant;
forming a panel of jurors to resolve the dispute, the jurors including one or more members of the network-based community; and
determining an outcome on the dispute based on input received from the jurors.

2. The method of claim 1, wherein each of the one or more members is a general juror.

3. The method of claim 1, wherein each of the one or more members is a specialist juror based on qualifications.

4. The method of claim 1, wherein the dispute involves the first disputant and a second disputant, and wherein the panel of jurors is selected by the first disputant and the second disputant.

5. The method of claim 1, wherein forming the panel of jurors comprises selecting the one or more jurors from a pool of potential jurors.

6. The method of claim 1, wherein forming the panel of jurors comprises inviting potential jurors based on preset criteria.

7. The method of claim 1, wherein forming the panel of jurors comprises receiving a voluntary request from a potential juror.

8. The method of claim 1, further comprising receiving a dispute resolution fee from the first disputant.

9. The method of claim 1, wherein determining the outcome comprises receiving one or more votes from the panel of jurors and determining a majority based on the one or more votes.

10. The method of claim 1, further comprising monitoring performance of a juror based on a length of time that the juror takes to make a decision.

11. The method of claim 1, further comprising monitoring performance of a juror based on whether a decision of the juror is more often a decision of a majority of the panel of jurors resolving the same dispute.

12. The method of claim 1, further comprising monitoring performance of a juror based on how often the juror fails to provide a vote within an allotted time.

13. The method of claim 1, further comprising monitoring performance of a juror based on a number of disputes the juror has voted on.

14. The method of claim 1, further comprising providing evidence associated with the dispute to the panel for review, the evidence including a description of the dispute and evidentiary information received from the first disputant or a second disputant.

15. The method of claim 1, further comprising providing compensation to the one or more jurors.

16. A machine-readable storage medium in communication with at least one processor, the machine-readable storage medium storing instructions which, when executed by the at least one processor, provides a method for community-based dispute resolution on a network, the method comprising:
receiving a request to resolve a dispute within a network-based community from a first disputant;
forming a panel of jurors to resolve the dispute, the jurors including one or more members of the network-based community; and
determining an outcome on the dispute based on input received from the panel.

17. A system for community-based dispute resolution on a network, the system comprising:
a dispute resolution wizard to receive a request to resolve a dispute within a network-based community from a first disputant;
a panel module to form a panel of jurors to resolve the dispute, the jurors including one or more members of the network-based community; and
a decision module to determine an outcome on the dispute based on input received from the panel.

18. The system of claim 17, further comprising a juror selection module to maintain a pool of pre-qualified jurors, the pre-qualified jurors including the one or more members of the network-based community.

19. The system of claim 17, further comprising a performance module to evaluate performance of the one or more members of the network-based community.

20. A system for community-based dispute resolution on a network, the system comprising:
a means for receiving a request to resolve a dispute within a network-based community from a first disputant;
a means for forming a panel of jurors to resolve the dispute, the jurors including one or more members of the network-based community; and
a means for determining an outcome on the dispute based on input received from the panel.
